(19) United States
(12) Patent Application Publication
(10) Pub. No.: US 2010/0160476 A1
(43) Pub. Date: Jun. 24, 2010

(54) FLAME-RETARDANT ADDITIVES

(75) Inventors: Manfred Döring, Worth (DE); Ulrich Arnold, Bruchsal (DE); Marcel Roth, Duesseldorf (DE); Emilie Barriau, Duesseldorf (DE); Ulrike Schmidt-Freytag, Duesseldorf (DE); Volker Alstädt, Hamburg (DE); Felipe Wolff Fabris, Bayreuth (DE)

Correspondence Address: HENKEL CORPORATION, One Henkel Way, ROCKY HILL, CT, 06067, US

(73) Assignee: HENKEL AG &CO. KGAA, Duesseldorf (DE)

(21) Appl. No.: 12/718,035

(22) Filed: Mar. 5, 2010

Related U.S. Application Data
(63) Continuation of application No. PCT/EP2008/061105, filed on Aug. 26, 2008.

(30) Foreign Application Priority Data
Sep. 5, 2007 (DE) 102007041988.2

(51) Int. Cl. C08J 3/28; C07F 9/28; C08K 5/50

(52) U.S. Cl. 522/76; 556/20; 556/18; 524/154; 524/121

(57) ABSTRACT

The present invention relates to a curable preparation, containing an epoxy resin system, an initiator, and at least one flame-retardant agent, selected from a compound of the formula KA, wherein K=mono, di, oligo, and/or polphosphonium cation, and A=low-coordinating anion, and to the sue of the compounds of the general formula KA as a flame-retardant agent for resins systems.

The present invention relates to a curable preparation, comprising an epoxy resin system, an initiator, and at least one flame-retardant, selected from a compound of the formula KA, wherein K=a mono, di, oligo, and/or polyphosphonium cation, and A=a weakly coordinating anion, and to the use of the compounds of the general formula KA as a flame-retardant for resin systems.

Increased requirements for the fire resistance of materials have led to the use of flame-retardant additives in materials in order to decisively improve the safety of many materials in regard to their flammability.

Thus, phosphonium salts or reaction products obtained from phosphonium salts are employed as flame-retardants in many areas of industry. Flame-retardants based on tetrakis(hydroxymethyl)phosphonium salts are employed e.g. for rendering cellulose flame retardant, especially for impregnating textiles (EP 595 142 or WO 8900217) and wood (GB 2 200 363). Reaction products of these salts with isocyanates or alkylene oxides find use as flame-retardant additives for polyurethanes (DE 1 030 4344). Moreover, phosphonium salts are described as flame-retardants for polycarbonates (JP 2001 288352) and as building blocks for flame-retarded polyester fibers (JP 2000 290834). Furthermore, phosphonium salts were described as flame-retardants for polyethylene, polypropylene, polyacrylic acid and butadiene/acrylonitrile-acrylonitrile/styrene copolymers (U.S. Pat. No. 3,309,425 by Gulham et al.).

A conventional flame-retardant system in epoxy resin systems is a combination of bromine-containing flame-retardants and antimony oxide flame-retardant synergists. However, these compounds are environmental pollutants. Due to its partial solubility in water, antimony oxide is particularly problematic. In addition to melamine cyanurate, phosphorus-containing compounds are also added to epoxy resin systems as flame-retardant compounds.

For example, U.S. Pat. No. 5,739,187 from Asano et al., discloses epoxy resin compositions which comprise a phosphorus-containing flame-retardant as encapsulates for semiconductors in order to avoid the use of antimony trioxide and brominated compounds.

Phosphonium salts are described as additives in the US patent application 2004/0166241 from Gallo et al., and US 2004/0217376 from Ahsan et al. Both claim an epoxy resin composition comprising an epoxy resin system, a suitable initiator, a flame-retardant, preferably comprising melamine cyanurate and a quaternary organo phosphonium salt. A synergistic effect was attributed to the quaternary organo phosphonium salt when combined with the flame-retardant and the initiator, in that the salt positively influences both the curing rate as well as the flame-retardant properties of the resin. In each case however, an additional flame-retardant is needed and the curing of the epoxy resin composition is by heat, generally by anionic polymerization.

The added quaternary organo phosphonium salt cations are further characterized in that the relevant counter ion is selected from the group of the nucleophilic halide, acetate or phosphate anions.

In addition, the use of phosphonium salts with weakly coordinating anions as latent polymerization catalysts in heat-curable resin systems is known from the JP patent application 2004083835.

When epoxy resins are cured by anionic polymerization or polyaddition, then the presence of conventional flame-retardant additives, for example the flame-retardant additives based on organo phosphonium salts, is mostly unproblematic. However, the anions of these additives (e.g. halides, acetates or phosphates) are often distinctly nucleophilic or basic and therefore inhibit cationic polymerization processes. Consequently they cannot be used in non-thermal curing, i.e. in the radiation cure of epoxy resins, which mainly follows a cationic mechanism, as in their presence the resins do not or only partially crosslink. Other flame-retardant additives, such as e.g. melamine cyanurate are also incompatible with a cationically polymerizable epoxy resin system.

Accordingly, the object of the present invention was the provision of efficient flame-retardant additives for non-thermally curing resin systems, as for this type of curing no compatible and effective flame-retardant additive is available. In order to obtain adequate flame retardancy, the flame-retardants are often added in quantities that lead to a worsening of the material parameters. Another object of the invention was therefore to keep the required additive levels as low as possible in order not to detrimentally influence the material properties.

Surprisingly, it has now been found that mono-, di-, oligo- and polyphosphonium cations that contain weakly coordinating anions as the counter ions represent highly efficient flame-retardants for resin systems. Due to the sterically hindered and weakly nucleophilic anions, these flame-retardant additives are also suitable for non-thermally curable epoxy resin systems, for example, as they do not negatively influence the polymerization process and thus permit a complete curing of the resin system, for example by the radiation curing that takes place in accordance with a cationic mechanism.

The subject matter of the present invention is accordingly the use of at least one compound of the general formula (I),

KA (I)

as flame-retardants for resin systems, with K=a mono-, di-, oligo- and/or polyphosphonium cation and A=a weakly coordinating anion, wherein the weakly coordinating anion A is selected from hexafluoroantimonate (SbF₆⁻), hexafluorophosphate (PF₆⁻), tetrafluoroborate (BF₄), hexafluoroaluminate (AlF₆³⁻), trifluoromethane sulfonate (CF₃SO₃⁻), hexafluoroarsenate (AsF₆⁻), tetrakis(pentafluorophenyl)borate (B[C₆F₅]₄⁻), tetrakis[3,5-bis(trifluoromethyl)-phenyl]borate (B[C₆H₃(CF₃)₂]₄⁻), tetraphenylborate (B[C₆H₅]₄⁻), hexafluorotitanate (TiF₆²⁻), pentachlorotitanate (TlCl₅⁻), pentachlorostannate (SnCl₅⁻), hexafluorogermanate (GeF₆²⁻), hexafluorosilicate (SiF₆²⁻), hexafluoronickelate (NiF₆²⁻) or hexafluorozirconate (ZrF₆²⁻).

In the context of the invention, the term, “resin systems” is understood to mean resin systems preferably selected from the group of the epoxy resin systems, benzoxazine systems, polyurethane systems, acrylate resin systems, epoxy acrylate resin systems, cyano acrylate resin systems, triazine resin systems, polyimide resin systems, acrylate ester resin systems and/or thermoplastic resin systems or any of their mixtures. Non-thermal curable resin systems are particularly preferred, non-thermal curable epoxy resin systems are quite particularly preferred, which in the context of the invention can also be regarded as cationically curable epoxy resin systems.

“Weakly coordinating anions” in the context of the invention are preferably understood to mean anions that due to their chemical structure are weakly basic and possess hardly any nucleophilic properties. In the absence of weakly coordinating anions as the counter ions, the resin system is generally not or incompletely cured because other counter ions, such as for example halides, inhibit or decisively slow down the polymerization process, particularly for cationically curable systems.

Another subject matter of the present invention is a curable preparation comprising

a) an epoxy resin system,

b) an initiator selected from the following compounds or their mixtures:
i) compounds of the general formula (XV),

{[M(L)ₐ]A_{b}}_{c} (XV),
with M=metal cation, L=ligand, A=weakly coordinating anion, a=1 to 10, preferably 1 to 6, particularly preferably 1 to 4, b=1 to 10, preferably 1 to 6, particularly preferably 1 to 3 and c=1 to 20 000 000, preferably 1 to 20 000, particularly preferably 1 to 1000, quite particularly preferably 1 to 500, especially 1 to 300, wherein a, b and c can represent whole numbers and numerical ranges and a can also additionally represent non whole numbers,
ii) compounds of the general formula (XVI),

IA (XVI)
with I=diaryliodonium salt and A=weakly coordinating anion or
iii) compounds of the general formula (XVII),

SA (XVII)
with S=triarylsulfonium salt and A=weakly coordinating anion, and

c) at least one flame-retardant of the general formula (I)

KA (I),
with K=mono-, di-, oligo- and/or polyphosphonium cation and A=weakly coordinating anion,
   wherein the weakly coordinating anion A of the initiator and of the flame-retardant is selected from hexafluoroantimonate (SbF₆⁻), hexafluorophosphate (PF₆⁻), tetrafluoroborate (BF₄⁻), hexafluoroaluminate (AlF₆³⁻), trifluoromethane sulfonate (CF₃SO₃⁻), hexafluoroarsenate (AsF₆⁻), tetrakis(pentafluorophenyl)borate (B[C₆F₅]₄⁻), tetrakis[3,5-bis(trifluoromethyl)phenyl]borate (B[C₆H₃(CF₃)₂]₄⁻), tetraphenylborate (B[C₆H₅]₄⁻), hexafluorotitanate (TiF₆²⁻), pentachlorotitanate (TlCl₅⁻), pentachlorostannate (SnCl₅⁻), hexafluorogermanate (GeF₆²⁻), hexafluorosilicate (SiF₆²⁻), hexafluoronickelate (NiF₆²⁻) or hexafluorozirconate (ZrF₆²⁻).

In the context of the invention, an epoxy resin system is understood to mean a resin composition that is formed based on epoxide compounds or epoxide-containing compounds.

According to the invention, a, b and c in formula (XV) can represent both whole numbers as well as ranges of numbers and a can additionally also represent non whole numbers.

In particular a is preferably a number in the range from 1 to 6 and particularly preferably from 1 to 4. More preferably a=1, 1.5, 2, 3 or 4, quite particularly preferably 1, 1.5 or 2.

In particular b is preferably a number in the range from 1 to 6 and particularly preferably from 1 to 3. More preferably b=1, 2, 3 or 4, quite particularly preferably 1, 2 or 3.

c is preferably either 1 (monomeric metal complex) or is preferably in a range of 1 to 20 000 000 (monomeric, dimeric, trimeric, oligomeric and polymeric coordination compounds or mixtures thereof), for example preferably 1 to 20 000, particularly preferably 1 to 1000, quite particularly preferably 1 to 500 or 1 to 300. More preferably, however, c is a number in the range between 1 and 20 000 000.

A further subject matter of the present invention is the use of the inventive preparation as an adhesive, composite material, sealing compound, material and/or for coating surfaces.

Likewise, a subject matter of the present invention is a process for curing the inventive preparation comprising the steps
a. providing a curable preparation,
b. irradiating said preparation with sufficient radiation to cure said preparation
   and the cured product as such, which is obtained by non-thermal curing of the inventive preparation, preferably by the abovementioned process.

In the context of the present invention, flame-retardant additives consist of mono-, di-, oligo- and/or polyphosphonium cations and the above-mentioned weakly coordinating anions.

In a preferred embodiment of the flame-retardant additive, the monophosphonium cation is selected from compounds of the general formula (II),

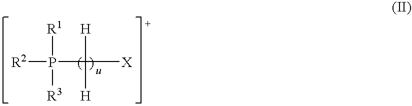

wherein u is a whole number between 0 and 18, R¹, R² and R³ independently of each other stand for a substituted or unsubstituted C₁₋₁₂ alkyl, cycloalkyl, alkenyl, alkynyl, arylalkyl or aryl group, in particular a C₆₋₁₀ aryl group, and X stands for a C₁₋₁₂ alkyl, alkenyl, cycloalkyl, arylalkyl, aryl, carboxylic acid or carboxylic acid ester group or a group of the general formula R⁴C═O, with R⁴=substituted or unsubstituted C₁₋₁₂ alkyl, cycloalkyl, arylalkyl or aryl group.

Preferably, u=0, 1, 2 or 3, in particular 1 and/or R¹, R² and R³ stand for a substituted or unsubstituted phenyl group. In a quite particularly preferred embodiment, R¹═R²═R³=phenyl and X stands for a substituted or unsubstituted vinyl group or acyl group of the general formula R⁴(C═O)—, with R⁴=phenyl.

In another preferred embodiment of the flame-retardant additive, the diphosphonium cation is selected from compounds of the general formula (III),

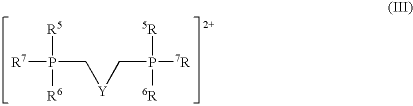

wherein R⁵ and R⁶, independently of each other stand for a substituted or unsubstituted C₁₋₁₂ alkyl, cycloalkyl, alkenyl, alkynyl, arylalkyl or aryl group, in particular a C₆₋₁₀ aryl group, R⁷ stands for a substituted or unsubstituted C₁₋₁₂ alkyl, cycloalkyl, alkenyl, alkynyl, arylalkyl or aryl group or for a structure of the general formula R⁸C═O(CH₂)ᵤ—, with u=1 to 10 and R⁸=substituted or unsubstituted C₁₋₁₂ alkyl, cycloalkyl, arylalkyl or aryl group, and Y stands for a covalent bond or a substituted or unsubstituted C₁₋₁₂ alkylene, cycloalkylene, alkenylene, arylalkylene or arylene group.

R⁵ and R⁶ preferably stand for a substituted or unsubstituted phenyl group. In a quite particularly preferred embodiment of the invention, R⁵═R⁶=phenyl and/or Y stands for a covalent bond or a para-phenylene group. In an additional preferred embodiment of the invention, R⁷ stands for a substituted or unsubstituted phenyl group or R⁷ stands for a group of the general formula R⁸C═O(CH₂)ᵤ—, with u=1, 2 or 3, in particular 1 and/or R⁸ stands for a phenyl group.

In a further preferred embodiment of the flame-retardant additive, the oligo- or polyphosphonium cation is selected from compounds of the general formula (IV),

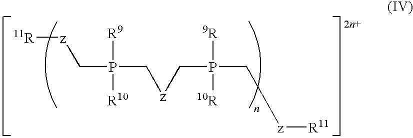

wherein n is a whole number between 1 and 20 000 000, R⁹ and R¹⁰ independently of each other stand for a substituted or unsubstituted C₁₋₁₂ alkyl, cycloalkyl, alkenyl, alkynyl, arylalkyl or aryl group, in particular a C₆₋₁₀ aryl group, z for a covalent bond or a substituted or unsubstituted C₁₋₁₂ alkylene, cycloalkylene, alkenylene, arylalkylene or arylene group and R¹¹ stands for a structure of the general formula (R¹²)₃P(CH₂)ⱼ— with j=0 to 10 and R¹²=substituted or unsubstituted C₁₋₁₂ alkyl, cycloalkyl, arylalkyl or aryl group, in particular a C₆₋₁₀ aryl group.

Preferably, n stands for a whole number between 1 and 1 000 000, particularly preferably between 1 and 100 000 and quite particularly preferably between 1 and 10 000, between 1 and 1000, between 1 and 300, between 1 and 100 and in particular between 1 and 10. In a further preferred embodiment of the invention, R⁹ and R¹⁹ stand for a substituted or unsubstituted phenyl group. In a quite particularly preferred embodiment of the invention, R⁹═R¹⁰=phenyl and/or z stands for a covalent bond or a para-phenylene group.

In an additional preferred embodiment of the invention, R¹¹ stands for a structure of the general formula (R¹²P(CH₂)ⱼ—, wherein j is 0, 1, 2 or 3, in particular 1 and/or R¹² stands for a substituted or unsubstituted phenyl group.

In the context of the present invention, the term, “substituted” means that the relevant group can carry at least one, preferably one, two or three substituents.

According to the invention the substituents can be particularly selected from alkyl, in particular C₁₋₂₂ alkyl, preferably C₁₋₁₈ alkyl, trifluoromethyl, cycloalkyl, in particular C₃₋₈ cycloalkyl, cycloalkylalkyl, in particular C₃₋₈ cycloalkyl-C₁₋₁₂ alkyl, alkenyl, in particular C₂₋₁₈ alkenyl, alkynyl, in particular C₂₋₁₈ alkynyl, heteroalkyl, heterocycloalkyl, alkoxy, in particular C₁₋₁₂alkoxy, alkylsulfanyl, in particular C₁₋₁₈ alkylsulfanyl, alkylsulfinyl, in particular C₁₋₁₈ alkylsulfinyl, alkylsulfonyl, in particular C₁₋₁₈ alkylsulfonyl, alkanoyl, in particular C₁₋₁₈ alkanoyl, alkanoyloxy, in particular alkoxycarbonyl, in particular C₁₋₁₈ alkoxycarbonyl, alkylaminocarbonyl, in particular C₁₋₁₈ alkylaminocarbonyl, alkylsulfanylcarbonyl, in particular C₁₋₁₈ alkylsulfanylcarbonyl, hydroxy, amino, aryl, in particular C₆₋₁₀ aryl, arylalkyl, in particular C₆₋₁₀ aryl-C₁₋₁₂ alkyl, aryloxy, in particular C₆₋₁₀ aryloxy, arylsulfanyl, in particular C₆₋₁₀ arylsulfanyl, arylsulfinyl, in particular C₆₋₁₀ arylsulfinyl, arylsulfonyl, in particular C₆₋₁₀ arylsulfonyl, arylcarbonyl, in particular C₆₋₁₀ arylcarbonyl, arylcarbonyloxy, in particular C₆₋₁₀ arylcarbonyloxy, aryloxycarbonyl, in particular C₆₋₁₀ aryloxycarbonyl, heteroaryl, heteroarylalkyl, in particular heteroaryl C₁₋₁₂ alkyl, heteroaryloxy, heteroarylamino, heteroarylsulfanyl, heteroarylsulfonyl, heteroarylsulfoxidyl, heteroarylcarbonyl, heteroarylcarbonyloxy, heteroaryloxycarbonyl, heteroarylaminocarbonyl, heteroarylsulfanylcarbonyl, alkoxysulfonyl, in particular C₁₋₁₈ alkoxysulfonyl, alkoxycarbinol, in particular C₁₋₁₂ alkoxycarbinol, ammonium, hydroxycarbonyl, alkoxycarbonyl, in particular C₁₋₁₈ alkoxycarbonyl, aryloxycarbonyl, in particular C₆₋₁₀ aryloxycarbonyl, amidocarbonyl, halogen, in particular chloride, bromide, iodide or fluoride, nitro, sulfato, sulfo, amidosulfo, phosphato, phosphono, amidophosphono, formyl, thioformyl, —(CH₂—CH₂—O—)ₙH and —(CH₂—CH₂—CH₂—O)ₙH with n=1 to 20, preferably 3 to 20, wherein all groups of the resulting molecule, in particular the aliphatic and aromatic groups independently of each other can each be also optionally mono or polysubstituted, in particular mono-, di- or tri-substituted, preferably mono-substituted, in particular by substituents selected from the previously cited groups.

In a preferred embodiment, the substituents stand, independently of each other, for hydrogen, alkyl, in particular C₁₋₂₂ alkyl, preferably C₁₋₁₈ alkyl, trifluoromethyl, cycloalkyl, in particular C₃₋₈ cycloalkyl, cycloalkylalkyl, in particular C₃₋₈ cycloalkyl-C₁₋₁₂ alkyl, alkenyl, in particular C₂₋₁₈ alkenyl, alkynyl, in particular C₂₋₁₈ alkynyl, heteroalkyl, heterocycloalkyl, alkanoyl, in particular C₁₋₁₈ alkanoyl, alkoxycarbonyl, in particular C₁₋₁₈ alkoxycarbonyl, alkylaminocarbonyl, in particular C₁₋₁₈ alkylaminocarbonyl, alkylsulfanylcarbonyl, in particular C₁₋₁₈ alkylsulfanylcarbonyl, aryl, in particular C₆₋₁₀ aryl, arylalkyl, in particular C₆₋₁₀ aryl-C₁₋₁₂ alkyl, arylcarbonyl, in particular C₆₋₁₀ arylcarbonyl, aryloxycarbonyl, in particular C₆₋₁₀ aryloxycarbonyl, arylaminocarbonyl, in particular C₆₋₁₀ arylaminocarbonyl, arylsulfanylcarbonyl, in particular C₆₋₁₀ arylsulfanylcarbonyl, heteroaryl, heteroarylalkyl, in particular heteroaryl C₁₋₁₂ alkyl, heteroarylcarbonyl, heteroarylaminocarbonyl, heteroarylsulfanylcarbonyl, trifluoromethyl, formyl, —(CH₂—CH₂—O—)ₙH and —(CH₂—CH₂—CH₂—O)ₙH with n=1 to 20, wherein all groups of the resulting molecule, in particular the aliphatic and aromatic groups independently of each other can each be also optionally mono or polysubstituted, in particular mono-, di- or tri-substituted, preferably mono-substituted, in particular by substituents selected from the previously cited groups, as well as selected from ammonium, hydroxycarbonyl, alkoxycarbonyl, in particular C₁₋₁₈ alkoxycarbonyl, aryloxycarbonyl, in particular C₆₋₁₀ aryloxycarbonyl, amidocarbonyl, halogen, in particular chloride, bromide, iodide or fluoride, nitro, sulfato, sulfo, amidosulfo, phosphato, phosphono, amidophosphono, hydroxy, alkoxy, in particular C₁₋₁₈ alkoxy, amino and alkanoyloxy, in particular C₁₋₁₈ alkanoyloxy.

Particularly preferred flame-retardants are selected from compounds corresponding to formula (V) to (XII),

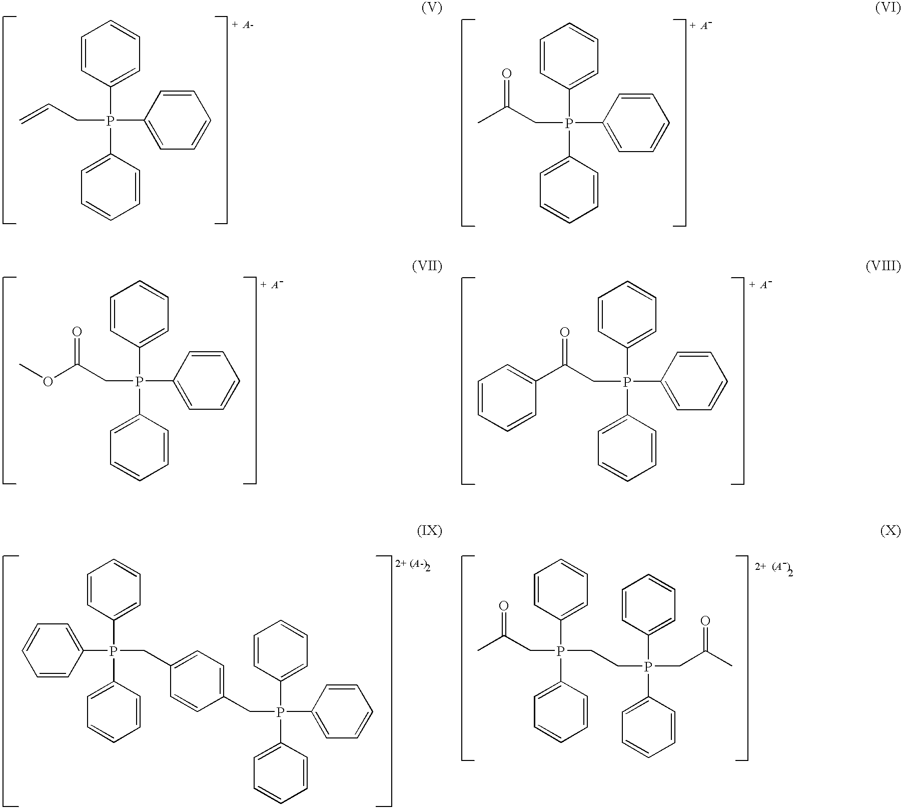

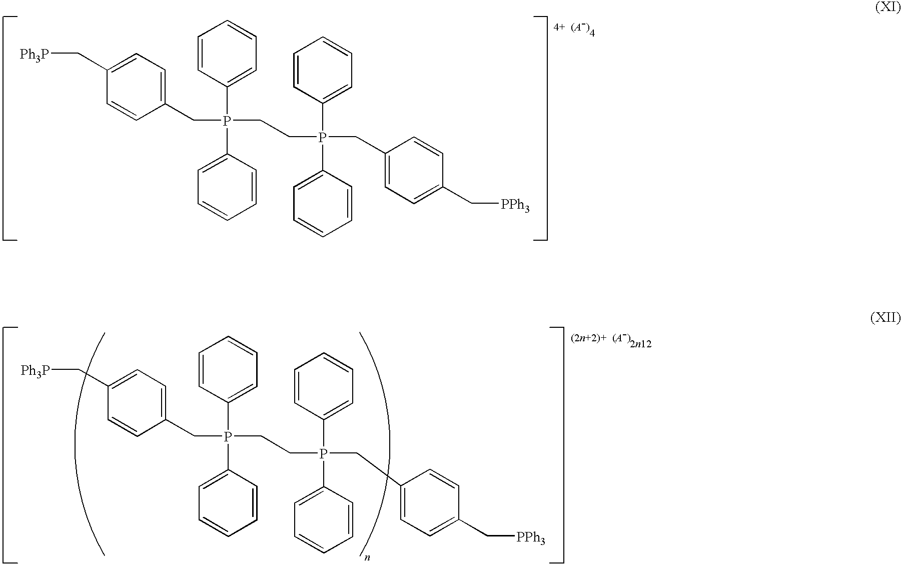

wherein n in formula (XII) is a whole number between 1 and 20 000 000. Preferably, n in formula (XII) stands for a whole number between 1 and 1 000 000, particularly preferably between 1 and 100 000 and quite particularly preferably between 1 and 10 000, between 1 and 1000, between 1 and 300, between 1 and 100 and in particular between 1 and 10.

In an exceedingly preferred embodiment of the flame-retardant, the weakly coordinating anion A is a hexafluoroantimonate (SbF₆⁻).

Accordingly, hexafluoroantimonates of compounds of the general formula (VII), (X), (XI) and (XII) are also the subject matter of the present invention.

The cited compounds can be obtained by treating the halides of formula (VII), (X), (XI) and (XII) with metal SbF₆ salts, in particular KSbF₆, wherein the reaction is preferably carried out in an aqueous medium.

The description of the inventive flame-retardants relates both to their use as well as to their application in the curable preparation that includes an epoxy resin system, at least one initiator and at least one flame-retardant.

The di-, oligo- or polyphosphonium cations of the compounds of formula (X) to (XII) can be manufactured by treating phosphines selected from the group of the alkyl-, arylalkyl- or arylphosphines, in particular triphenylphosphine and/or 1,2-bis-(diphenylphosphino)ethane, with alkyl halides selected from compounds of formula (XIII) or (XIV),

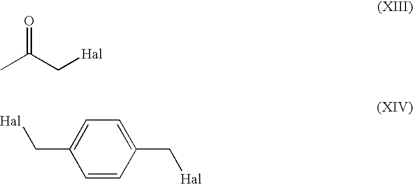

where Hal=F, Cl, Br or I.

The combination of the inventive polyphosphonium cations with weakly coordinating, sterically hindered and slightly basic anions as the counter ions affords a series of advantages.

Firstly, the inventive flame-retardants can be manufactured starting from the phosphonium salts in an efficient and cost-effective process by ion exchange with corresponding metal salts.

Secondly, the inventive flame-retardants are characterized by a very good solubility in the respective resin system, preferably in the epoxy resin system, thereby enabling an exceedingly wide formulation latitude.

The results of the demanding UL 94 vertical burn test when using the inventive phosphonium salts as the flame-retardants in epoxy resin systems are particularly noteworthy and surprising. In this vertical burn test, all investigated systems clearly demonstrated flame-retardant properties and satisfy at least the overall classification V1, even at low additive contents (10 to 20 wt. % in the resin), and without any added additional flame-retardant (synergists). In this regard, the phosphorus and antimony contents in the resin formulations are very low (see example 4). Due to their basic and/or nucleophilic character, currently available flame-retardants could not be used for radiation curing (which involves a cationic mechanism) of epoxy resin systems, as in their presence the resins do not or only incompletely crosslink. The inventive flame-retardants offer the advantage that for a curing of this type they do not impede the polymerization process, but by releasing extremely strong acids, such as for example HSbF₆, even accelerate the process, and therefore can be employed as effective flame-retardants and polymerization accelerators in cationic polymerizable resin systems.

As already stated, a subject matter of the present invention is a curable preparation comprising

a) an epoxy resin system,

b) an initiator selected from the following compounds or their mixtures:
i) compounds of the general formula (XV),

{[M(L)ₐ]A_{b}}_{c} (XV)
with M=metal cation, L=ligand, A=weakly coordinating anion, a=1 to 10, preferably 1 to 6, particularly preferably 1 to 4, b=1 to 10, preferably 1 to 6, particularly preferably 1 to 3 and c=1 to 20 000 000, preferably 1 to 20 000, particularly preferably 1 to 1000, quite particularly preferably 1 to 500, especially 1 to 300, wherein a, b and c can represent whole numbers and numerical ranges and a can also additionally represent non whole numbers,
ii) compounds of the general formula (XVI),

IA (XVI)
with I=diaryliodonium salt and A=weakly coordinating anion or
iii) compounds of the general formula (XVII),

SA (XVII)
with S=triarylsulfonium salt and A=weakly coordinating anion,

c) at least one flame-retardant of the general formula (I)

KA (I)
with K=mono-, di-, oligo- and/or polyphosphonium cation and A=weakly coordinating anion, wherein the weakly coordinating anion A of the initiator and of the flame-retardant is selected from hexafluoroantimonate (SbF₆⁻), hexafluorophosphate (PF₆⁻), tetrafluoroborate (BF₄⁻), hexafluoroaluminate (AlF₆³⁻), trifluoromethane sulfonate (CF₃SO₃⁻), hexafluoroarsenate (AsF₆⁻), tetrakis(pentafluorophenyl)borate (B[C₆F₅]₄⁻), tetrakis[3,5-bis(trifluoromethyl)phenyl]borate (B[C₆H₃(CF₃)₂]₄⁻), tetraphenylborate (B[C₆H₅]₄⁻), hexafluorotitanate (TiF₆²⁻), pentachlorotitanate (TlCl₅⁻), pentachlorostannate (SnCl₅⁻), hexafluorogermanate (GeF₆²⁻), hexafluorosilicate (SiF₆²⁻), hexafluoronickelate (NiF₆²⁻) or hexafluorozirconate (ZrF₆²⁻).

In the context of the invention, an epoxy resin system is understood to mean a resin composition that is formed on the basis of epoxide compounds or epoxide-containing compounds.

In a preferred embodiment of the invention, the epoxide compounds or epoxide-containing compounds of the epoxy resin system of the preparation can include both oligomeric as well as monomeric epoxide compounds as well as epoxides of the polymeric type, and can be aliphatic, cycloaliphatic, aromatic or heterocyclic compounds. The epoxide compounds or epoxide-containing compounds of the epoxy resin system generally possess on average at least one polymerisable epoxide group per molecule, preferably at least 1.5 polymerisable epoxide groups per molecule. The polymeric epoxides include linear polymers with terminal epoxide groups (e.g. a diglycidyl ether of a polyoxyalkylene glycol), polymers with oxirane moieties in the molecular structure (e.g. polybutadiene-polyepoxide) as well as polymers with pendant epoxide groups (e.g. a glycidyl methacrylate polymer or copolymer). These epoxides can be pure compounds or mixtures, which comprise one, two or more epoxide groups per molecule. The “average” number of epoxide groups per molecule is determined by dividing the total number of epoxide groups in the epoxide-containing material by the total number of the epoxide molecules present.

The molecular weight of the epoxide compounds or epoxide-containing compounds of the epoxy resin system varies from 100 g/mol up to a maximum of 10 000 g/mol for polymeric epoxy resins. In regard to the nature of their basic structure and their substituent groups, there are also no limits set for the epoxide compounds or for the epoxide-containing compounds. Thus the basic structure can belong to any type for example, and the substituents groups found on it can represent all groups that do not essentially interfere with curing.

Exemplary substituent groups include halides, ester groups, ethers, sulfonate groups, siloxane groups, nitro groups, phosphate groups and the like.

In the context of the present invention, exemplary suitable epoxy resin systems are preferably selected from epoxy resins of the bisphenol-A type, epoxy resins of the bisphenol-S type, epoxy resins of the bisphenol-F type, epoxy resins of the phenol-Novolak type, epoxy resins of the cresol-Novolak type, epoxidized products of numerous dicyclopentadiene-modified phenol resins, obtained by treating dicyclopentadiene with numerous phenols, epoxidized products of 2,2′,6,6′-tetramethylbiphenol, aromatic epoxy resins such as epoxy resins with a naphthalene basic structure and epoxy resins with a fluorene basic structure, aliphatic epoxy resins such as neopentyl glycol diglycidyl ether and 1,6-hexane diol diglycidyl ether, alicyclic epoxy resins such as 3,4-epoxycyclohexylmethyl-3,4-epoxycyclohexane carboxylate and bis(3,4-epoxycyclohexyl)adipate, and epoxy resins with a heterocycle such as triglycidyl isocyanurate.

In particular, the epoxy resins include for example the reaction product from Bisphenol A and epichlorohydrin, the reaction product of phenol and formaldehyde (Novolak resins) and epichlorohydrin, glycidyl esters as well as the reaction product from epichlorohydrin and p-aminophenol.

Further preferred epoxy resins that are commercially available include in particular octadecylene oxide, epichlorohydrin, styrene oxide, vinylcyclohexene oxide, glycidol, glycidyl methacrylate, diglycidyl ether of bisphenol A (e.g. those obtainable under the trade names “Epon 828”, “Epon 825”, “Epon 1004” and “Epon 1010” from Hexion Specialty Chemicals Inc., “DER-331”, “DER-332”, “DER-334”, “DER-732” and “DER736” from Dow Chemical Co.), vinylcyclohexene dioxide, 3,4-epoxycyclohexylmethyl-3,4-epoxycyclohexene carboxylate, 3,4-epoxy-6-methylcyclohexylmethyl-3,4-epoxy-6-methylcyclohexene carboxylate, bis(3,4-epoxy-6-methylcyclohexylmethyl) adipate, bis(2,3-epoxycyclopentyl)ether, aliphatic epoxide, modified with polypropylene glycol, dipentene dioxide, epoxidized polybutadiene (e.g. Krasol products from Sartomer), silicone resins containing epoxide functionality, flame-retardant epoxy resins (e.g. “DER-580”, a brominated epoxy resin of the Bisphenol type, which can be obtained from Dow Chemical Co.), 1,4-butane diol diglycidyl ether of a phenol-formaldehyde Novolak (e.g. “DEN-431” and “DEN-438” from Dow Chemical Co.), and resorcinol diglycidyl ether (e.g. “Kopoxite” from Koppers Company Inc.), bis(3,4-epoxycyclohexyl) adipate, 2-(3,4-epoxycyclohexyl-5,5-spiro-3,4-epoxy)cyclohexane-meta-dioxane, vinylcyclohexene monoxide, 1,2-epoxyhexadecane, alkyl glycidyl ethers such as e.g. C₈-C₁₀ alkyl glycidyl ethers (e.g. “HELOXY Modifier 7” from Hexion Specialty Chemicals Inc.), C₁₂-C₁₄ alkylglycidyl ether (e.g. “HELOXY Modifier 8” from Hexion Specialty Chemicals Inc.), butyl glycidyl ether (e.g. “HELOXY Modifier 61” from Hexion Specialty Chemicals Inc.), cresyl glycidyl ether (e.g. “HELOXY Modifier 62” from Hexion Specialty Chemicals Inc.), p-tert.-butylphenyl glycidyl ether (e.g. “HELOXY Modifier 65” from Hexion Specialty Chemicals Inc.), polyfunctional glycidyl ethers such as e.g. diglycidyl ether of 1,4-butane diol (e.g. “HELOXY Modifier 67” from Hexion Specialty Chemicals Inc.), diglycidyl ether of neopentyl glycol (e.g. “HELOXY Modifier 68” from Hexion Specialty Chemicals Inc.), diglycidyl ether of cyclohexane dimethanol (e.g. “HELOXY Modifier 107” from Hexion Specialty Chemicals Inc.), trimethylolethane triglycidyl ether (e.g. “HELOXY Modifier 44” from Hexion Specialty Chemicals Inc.), trimethylolpropane triglycidyl ether (e.g. “HELOXY Modifier 48” from Hexion Specialty Chemicals Inc.), polyglycidyl ethers of an aliphatic polyol (e.g. “HELOXY Modifier 84” from Hexion Specialty Chemicals Inc.), polyglycol diepoxide (e.g. “HELOXY Modifier 32” from Hexion Specialty Chemicals Inc.), bisphenol F epoxide (e.g. “EPN-1138” or GY-281″ from Huntsman Int. LLC), 9,9-bis-4-(2,3-epoxypropoxy)-phenylfiuorenone (e.g. “Epon 1079” from Hexion Specialty Chemicals Inc.).

Further preferred commercially available compounds are e.g. selected from Araldite™ 6010, Araldite™ GY-281™, Araldite™ ECN-1273, Araldite™ ECN-1280, Araldite™ MY-720, RD-2 from Huntsman Int. LLC; DEN™ 432, DEN™ 438, DEN™ 485 from Dow Chemical Co., Epon™ 812, 826, 830, 834, 836, 871, 872, 1001, 1031 etc. from Hexion Specialty Chemicals Inc. and HPT™ 1071, HPT™ 1079 also from Hexion Specialty Chemicals Inc., as the Novolak resins e.g. Epi-Rez™ 5132 from Hexion Specialty Chemicals Inc., ESCN-001 from Sumitomo Chemical, Quatrex 5010 from Dow Chemical Co., RE 305S from Nippon Kayaku, Epiclon N673 from DaiNippon Ink Chemistry or Epicote 152 from Hexion Specialty Chemicals Inc.

Melamine resins, such as e.g. Cymel TM-327 and 323 from Cytec, can also be used as the reactive resins.

Terpene phenol resins, such as e.g. NIREZTM 2019 from Arizona Chemicals, can also be used as the reactive resins.

Phenol resins, such as e.g. YP 50 from Iota Kasei, PKHC from Dow Chemical Co. and BKR 2620 from Showa Union Gosei Corp, can also be used as the reactive resins.

Polyisocyanates, such as e.g. Coronate™ L from Nippon Polyurethane Ind., Desmodur™ N3300 or Mondur™ 489 from Bayer, can also be used as the reactive resins.

Additional epoxy resins can be advantageously copolymers of acrylic acid esters with glycidol such as e.g. glycidyl acrylate and glycidyl methacrylate with one or more copolymerizable vinyl compounds. Examples of such copolymers are 1:1 styrene-glycidyl methacrylate, 1:1 methyl methacrylate-glycidyl acrylate and 62.5:24:13.5 methyl methacrylate-ethyl acrylate-glycidyl methacrylate.

Further suitable epoxy resins are well known and comprise epoxides such as e.g. epichlorohydrin; alkylene oxides, e.g. propylene oxide, styrene oxide; alkenyl oxides, e.g. butadiene oxide; glycidyl esters, e.g. ethyl glycidate.

Further suitable epoxy resins are silicones with epoxide functionality, in particular cyclohexyl epoxide groups, in particular those with a silicone backbone. Examples are UV 9300, UV 9315, UV 9400 and UV 9425, which are all supplied by GE Bayer Silicones.

In a preferred embodiment, the inventive preparations contain a mixture of a plurality of the cited epoxy resin systems.

Examples of such mixtures can contain two or more molecular weight distributions for the epoxide-containing compounds, such as e.g. a low molecular weight (below 200), an average molecular weight (ca. 200 to 10 000) and a high molecular weight (above ca. 10 000). Alternatively or additionally, the epoxy resin can comprise a mixture of epoxide-containing materials of a different chemical nature (e.g. aliphatic or aromatic) or functionality (e.g. polar or non-polar).

The initiator for the inventive preparation is preferably selected from compounds of the general formula (XV)

{[M(L)ₐ]A_{b}}_{c} (XV).

According to the invention, a, b and c in formula (XV) can represent both whole numbers as well as ranges of numbers and a can additionally also represent non whole numbers. In particular a is preferably a number in the range from 1 to 6 and particularly preferably from 1 to 4. More preferably a=1, 1.5, 2, 3 or 4, quite particularly preferably 1, 1.5 or 2.

In particular b is preferably a number in the range from 1 to 6 and particularly preferably from 1 to 3. More preferably b=1, 2, 3 or 4, quite particularly preferably 1, 2 or 3.

c is preferably either 1 (monomeric metal complex) or is preferably in a range 1 to 20 000 000 (monomeric, dimeric, trimeric, oligomeric and polymeric coordination compounds or mixtures thereof), for example preferably 1 to 20 000, particularly preferably 1 to 1000, quite particularly preferably 1 to 500 or 1 to 300. More preferably, however, c is a number in the range between 1 and 20 000 000.

When c=1 then this means according to the invention that monomeric coordination compounds are present. When c is a numerical range from 1 to p, then this means that in addition to monomeric coordination compounds there are also dimeric, trimeric, oligomeric and polymeric coordination compounds, so-called coordination polymers, and mixtures of these with different chain lengths.

Likewise preferred is an inventive, curable preparation, wherein the initiator according to formula (XV) for the preparation comprising at least one metal cation M, at least one ligand L and at least one hexafluoroantimonate (SbF₆⁻) as the weakly coordinating anion is obtained by a complex-forming reaction of a corresponding metal SbF₆ salt with an appropriate ligand (L).

In a preferred embodiment of the inventive preparation, the metal cation (M) of the initiator of formula (XV) can be selected from the group of the transition metals from the fourth or fifth periods or from the second or third main groups of the periodic table. The metal cation (M) is particularly preferably selected from the group containing Ag, Fe, Mg, Co, Cu, Al or Ti.

In a further preferred embodiment of the preparation, the ligand (L) is a compound with at least one carbon-carbon double and/or triple bond, preferably a substituted or unsubstituted, branched or non-branched, cyclic or acyclic alkene or alkyne containing 1 to 30 carbon atoms.

In a further preferred embodiment, the ligand (L) is an ether, especially a cyclic ether, preferably a crown ether.

In a further preferred embodiment, the ligand (L) is a compound from the group of the nitriles. This type of compound contains at least one C≡N group.

Exemplary suitable ligands (L) are selected from propene, 1-butene, 1-pentene, 1-hexene, 1-octene, 1-decene, isoprene, norbornene, cyclohexene, cyclooctene, cyclodecene, 1,4-cyclohexadiene, 4-vinylcyclohexene, trans-2-octene, styrene, 5-norbornene-2-carboxylic acid, butadiene, 1,5-hexadiene, 1,6-heptadiene, 1,7-octadiene, 1,9-decadiene, ethyl sorbate, 1,3-cyclohexadiene, 1,3-cyclooctadiene, 1,5-cyclooctadiene, norbornadiene, dicyclopentadiene, cycloheptatriene, trans,trans,trans-1,5,9-cyclododecatriene, trans,trans,cis-1,5,9-cyclododecatriene, cyclooctatetraene, squalene, diallyl carbonate, diallyl ether, diallyl dimethylsilane, nopol, cyclopentadiene, ethyl vinyl ether, limonene, 1,2-dihydronaphthalene, ethyl cinnamate, ethyl acrylate, ethyl methacrylate, stilbene, methyl oleate, methyl linolate, methyl linoleate, diphenylacetylene, dimethylacetylene, 3-hexyne, 1,8-cyclotetradecadiyne, propargyl alcohol, vinylacetylene, 15-crown-5, 18-crown-6, 1-phenylpropyne, 1,8-nonadiyne, 18-crown-6-tetracarboxylic acid.

The precondition for forming dimeric, trimeric and oligomeric coordination compounds as well as coordination polymers is a polyfunctional ligand (L) that is capable of linking to a plurality of metal centers, thereby enabling the formation of dimeric, trimeric, oligomeric and polymeric structures. This is not possible for monoalkenes and alkynes and crown ethers, and exclusively mononuclear coordination compounds are preferably obtained i.e. monomeric complexes with only one metal center (the parameters a and b are variable, c=1). In the case of cyclic di-, tri or tetraenes (e.g. 1,5-cyclooctadiene, cycloheptatriene or cyclooctatetetraene), predominantly mononuclear metal complexes are preferably obtained although the formation of multinuclear ligand-bridged structures is also possible. If open-chain dienes are employed as the ligands L, then depending on the metal cation and anion, the formation of coordination polymers can also be favorized. If for example AgSbF₆ is treated with 1,7-octadiene, then {[Ag(1,7-octadiene)_{1.5}]SbF₆}_{c>1000} is preferably obtained, a coordination polymer with for example a one-dimensional chain structure (a=1.5, b=1, c>1000), in which the silver centers are preferably alternately bridged by 1 and 2 molecules of 1,7-octadiene:

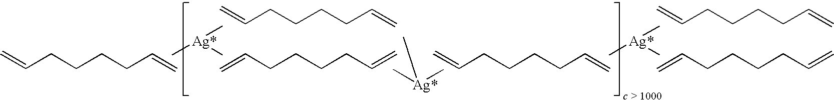

Similar structures result with the ligands 1,5-hexadiene and 1,9-decadiene. An increasing number of double bonds in the ligand always results in more branching possibilities, the resulting structures are more complex and mixtures of differently crosslinked oligomeric and polymeric coordination complexes are obtained, such as for example with the ligand squalene, an open-chain hexa-alkene. Polynuclear compounds are preferably also formed in addition to the mononuclear compounds.

In a particularly preferred embodiment of the preparation, the initiator according to formula (XV) is selected from [Ag(cyclohexene)₁₋₄]SbF₆, [Ag(cyclooctene)₁₋₄]SbF₆, [Ag(cyclododecene)₁₋₄]SbF₆, [Ag(trans-2-octene)₁₋₄]SbF₆, [Ag(styrene)₁₋₄]SbF₆, [Ag(5-norbornene-2-carboxylic acid)₁₋₄]SbF₆, {[Ag(1,5-hexadiene)₁₋₄]SbF₆}₁₋ₚ, {[Ag(1,7-octadiene)_{1.5}]SbF₆}ₚ, {[Ag(1,7-octadiene)_{1.5}]SbF₆}₁₀₀₀, {[Ag(1,7-octadiene)_{1.5}]SbF₆}₅₀₀, {[Ag(1,9-decadiene)₁₋₄]SbF₆}₁₋ₚ, {[Ag(ethyl sorbate)₁₋₄]SbF₆}₁₋ₚ, {[Ag(1,3-cyclohexadiene)₁₋₄]SbF₆}₁₋ₚ, {[Ag(1,3-cyclooctadiene)₁₋₄]SbF₆}₁₋ₚ, Ag(1,5-cyclooctadiene)₂]SbF₆, {[Ag(norbornadiene)₁₋₄]SbF₆}₁₋ₚ, {[Ag(dicyclopentadiene)₁₋₄]SbF₆}₁₋ₚ, {[Ag(cycloheptatriene)₁₋₄]SbF₆}₁₋ₚ, {[Cu(1,7-octadiene)₁₋₄]SbF₆}₁₋ₚ, [Cu(1,5-cyclooctadiene)₂]SbF₆, [Cu(15-crown-5)]SbF₆, [Fe(15-crown-5)](SbF₆)₃, [Fe(18-crown-6)](SbF₆)₃, [Mg(15-crown-5)](SbF₆)₂, [Co(15-crown-5)](SbF₆)₂, [Ag(1R-(−)-nopol)₁₋₄]SbF₆, [Ag(allyl glycidyl ether)₁₋₄]SbF₆, {[Ag(trans,trans,cis-1,5,9-cyclododecatriene)₁₋₄]SbF₆}₁₋ₚ, {[Ag(trans,trans,trans-1,5,9-cyclododecatriene)₁₋₄]SbF₆}₁₋ₚ, {[Ag(cyclooctatetraene)₁₋₄]SbF₆}₁₋ₚ, ([Ag(squalene)₁₋₄]SbF₆}₁₋ₚ, and/or from any mixtures thereof, wherein p=20 000 000

The initiator for the inventive preparation is also preferably selected from compounds of the general formula (XVI)

IA (XVI)
wherein I stands for a diaryliodinium salt and A is an inventive weakly coordinated anion.

Particularly preferred inventive initiators according to formula (XVI) are compounds according to formula (XVIII),

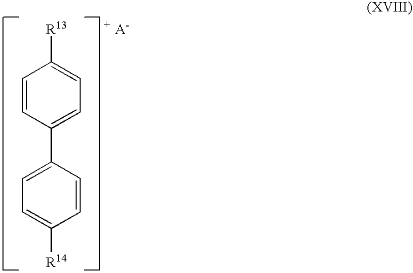

wherein R¹³ and R¹⁴ independently of one another are selected from the group consisting of hydrogen, methyl, ethyl, n-propyl, isopropyl, n-butyl, tert-butyl, Cl, Br, OCᵢH₂ᵢ₊₁, OCH₂CH(CH₃)CᵢH₂ᵢ₊₁, OCH₂CH(C₂H₅)CᵢH₂ᵢ₊₁, OCH₂CH(OH)CᵢH₂ᵢ₊₁, OCH₂CO₂CᵢH₂ᵢ₊₁, OCH(CH₃)CO₂CᵢH₂ᵢ₊₁, OCH(C₂H₅)CO₂CᵢH₂ᵢ₊₁ and i is a whole number between 0 and 18.

The initiator for the inventive preparation is also preferably selected from compounds of the general formula (XVII)

SA (XVII)
wherein S stands for a triarylsulfonium salt and A is an inventive weakly coordinated anion.

Particularly preferred initiators according to formula (XVII) are selected from compounds of formula (XIX) and/or formula (XX) or their mixtures,

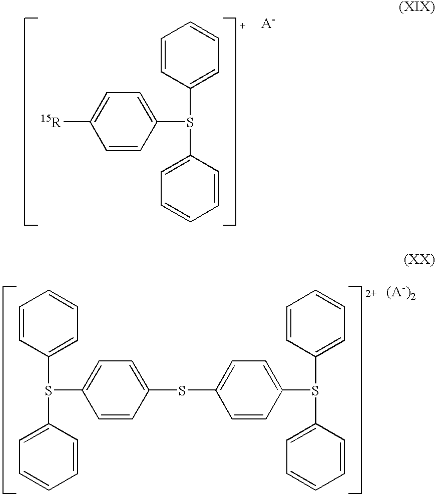

wherein R¹⁵ is selected from the group consisting of hydrogen, methyl, ethyl, n-propyl, isopropyl, n-butyl, tert-butyl, phenyl sulfide (PhS) and phenoxy (PhO).

The inventive initiators according to formula (XVI) and formula (XVII) are described as cationic initiators in the U.S. Pat. Nos. 5,726,216 and 5,877,229 from Janke et al. Examples of commercially available diaryliodonium salts and triarylsulfonium salts are (4-octyloxyphenyl)phenyliodonium hexafluoroantimonate, sold by General Electric Corporation as an aryl fluoroantimonate product 479-2092 and CYRACURE UVI-6974, CYRACURE UVI-6990 (Union Carbide Corporation), DEGACURE KI-85 (Degussa Corporation) and FX-512 from 3M Corporation.

In a further preferred embodiment of the curable preparation, the weakly coordinating anion A of the initiator and/or of the flame-retardant is hexafluoroantimonate (SbF₆⁻).

Preferably the fraction of the initiator is 0.01 to 10 wt. %, preferably 0.5 to 3 wt. % and particularly preferably 1 to 2 wt. %, and the fraction of the flame retardant is 0.01 to 50 wt. %, preferably 0.5 to 30 wt. %, particularly preferably 2 to 21 wt. % and especially 20 wt. % or 10 wt. %, each based on the total weight of the preparation.

Any mixtures of various inventive initiators and/or any mixtures of various inventive flame-retardants can also be used in the inventive preparations.

In the context of the invention, a preparation is likewise preferred that in addition to the cited components comprises at least one further component, selected from the group of the fillers, stabilizers, cure accelerators, antioxidants, thickeners, catalysts, reactive diluents, plasticizers, additional flame-retardant additives, impact additives, such as for example elastomers, thermoplastics, core-shell particles, nanoparticles, block copolymers and/or nanotubes.

Examples of suitable plasticizers are abietic acid esters, adipic acid esters, azelaic acid esters, benzoic acid esters, butyric acid esters, acetic acid esters, phosphoric acid esters, phthalic acid esters, esters of higher fatty acids with about 8 to about 44 carbon atoms, such as dioctyl adipate, di-isodecyl succinate, dibutyl sebacate or butyl oleate, esters of fatty acids with OH groups or epoxidized fatty acids, fatty acid esters and fats, glycolic acid esters, phosphoric acid esters, phthalic acid esters, of linear or branched alcohols with 1 to 12 carbon atoms, such as for example dioctyl phthalate, dibutyl phthalate or butyl benzyl phthalate, propionic acid esters, sebacic acid esters, sulfonic acid esters, thiobutyric acid esters, trimellitic acid esters, citric acid esters as well as esters based on nitrocellulose and polyvinyl acetate, as well as mixtures of two or more thereof. The asymmetric esters of difunctional, aliphatic dicarboxylic acids are particularly suitable, for example the esterified product of the monooctyl ester of adipic acid monooctyl ester with 2-ethylhexanol (Edenol DOA, Henkel, Düsseldorf).

Pure or mixed ethers of monofunctional, linear or branched C₄₋₁₆ alcohols or mixtures of two or more different ethers of such alcohols, for example dioctyl ether (available as Cetiol OE, Henkel, Düsseldorf) are also suitable as plasticizers.

In a further preferred embodiment, blocked end group polyethylene glycols are used as the plasticizers. For example polyethylene- or polypropylene glycol di-C₁₋₄ alkyl ethers, particularly the dimethyl or diethyl ethers of diethylene glycol or dipropylene glycol, as well as mixtures of two or more thereof.

The inventive preparation ran comprise up to about 80 wt. % of fillers. Suitable fillers are inorganic fillers, for example naturally occurring or synthetic materials such as e.g. quartz, nitrides (e.g. silicon nitride), e.g. glasses based on Ce, Sb, Sn, Zr, Sr, Ba and Al, colloidal silicon dioxide, feldspar, borosilicate glasses, kaolin, talc, titanium dioxide and zinc glasses, as well as silicon dioxide particles of sub micron size (e.g. pyrogenic silicon dioxides such as e.g. the silicon dioxides of the series “Aerosil” “Ox 50”, “130”, “150” and “200”, which are sold by Degussa, as well as “Cab-o-Sil M5”, which is sold by Cabot Corp.), aluminum silicates, magnesium silicates, zeolites, bentonites, ground minerals, calcium carbonates, quartz dust, silicic acid anhydride, silicon hydrate or carbon black, magnesium carbonate, fired clay, clay, iron oxide, zinc oxide, titanium dioxide, cellulose, wood flour, mica, chaff, graphite, fine aluminum powder or flint powder, glass spheres, glass powder, glass fibers and short chopped glass fibers as well as other inorganic fillers known to the person skilled in the art, as well as organic fillers, especially short chopped fibers or plastic hollow spheres, as well as functional fillers, which positively influence the rheological properties, for example highly dispersed silica, in particular with low BET-surfaces of 20-150, preferably 30-100, particularly preferably about 50 m²/g. Optionally, fillers can be added that lend thixotropy to the preparation, for example swellable plastics like PVC.

Suitable resin additives are all natural and synthetic resins, such as for example colophonium derivatives (for example derivatives obtained by disproportionation, hydrogenation or esterification), coumarone-indene resins and polyterpene resins, aliphatic or aromatic hydrocarbon resins (C-5, C-9, (C5)₂ resins), mixed C-5/C-9 resins, hydrogenated and partially hydrogenated of the cited types, styrene or α-methylstyrene resins as well as terpene-phenol resins and others as listed in Ullmanns Enzyklopádie der technischen Chemie (4. Ed.), Vol. 12, pp. 525-555, Weinheim.

Suitable solvents are water, ketones, lower alcohols, lower carboxylic acids, ethers and esters such as (meth)acrylic acid (esters), acetone, acetylacetone, acetoacetic acid esters, methyl ethyl ketone, methyl isobutyl ketone, cyclopentanone, cyclohexanone, N-methylpyrrolidone, dioxane, tetrahydrofuran, 2-methoxyethanol, 2-ethoxyethaol, 1-methoxy-2-propanol, 1,2-dimethoxyethane, ethyl acetate, n-butyl acetate, ethyl 3-ethoxypropionate, methanol, ethanol, iso-propanol, n-propanol, n-butanol, iso-butanol, sec-butanol, tert-butanol, diacetone alcohol, 2-ethylhexylalkohol, ethylene glycol, diethylene glycol, ethylene glycol dimethyl ether, ethylene glycol diethyl ether, ethylene glycol di-n-butyl ether, diethylene glycol, diethylene glycol dimethyl ether, diethylene glycol diethyl ether, diethylene glycol di-n-butyl ether, polyethylene glycols, formic acid, acetic acid or propionic acid, THF, dioxane, acetonitrile, propionitrile, dimethylformamide, dimethyl sulfoxide, sulfolane, dimethyl carbonate, diethyl carbonate, di-n-butyl carbonate, 1,2-ethylene carbonate, 1,2-propylene carbonate or 1,3-propylene carbonate as well as aromatic hydrocarbons, such as toluene and xylene.

The α-silanes that are preferred as adhesion promoters and/or reactive diluents can be advantageously selected from the group consisting of α-methacrylic-, α-carbamato silanes and α-alkoxy silanes.

Suitable examples are (methacryloxymethyl)methyldiethoxysilane and (methacryloxymethyl)triethoxysilane, N-(triethoxysilylmethyl)-O-methyl-carbamate and N-(methyldiethoxysilylmethyl)-O-methyl-carbamate.

In addition to radically (co)polymerized (co)polymers, the conventional organic and inorganic thickeners, such as hydroxymethyl cellulose or bentonite, can be used as the thickeners.

Morpholine, N-methylmorpholine, 1,3-diazabicyclo[5.4.6]undecene-7 (DBU) are particularly suitable catalysts for promoting crosslinking. Further suitable catalysts are those based on organic or inorganic heavy metal compounds for example cobalt naphthenate, dibutyltin dilaurate, tin mercaptides, tin dichloride, zirconium tetraoctoate, tin naphthenate, tin stearate, antimony dioctoate, lead dioctoate, metal acetylacetonates, especially iron acetylacetonate. In particular, all known catalysts for accelerating silanol condensation can be considered. These are for example organotin, organotitanium, organozirconium or organoaluminum compounds. Examples of such compounds are dibutyltin dilaurate, dibutyltin dimaleate, tin octoate, isopropyltriisostearoyititanate, isopropyltris(dioctylpyrophosphato)titanate, bis(dioctylpyrophosphato)oxyacetatotitanate, tetrabutyl zirconate, tetrakis(acetylacetonato)zirconium, tetraisobutyl zirconate, butoxytris(acetylacetonato)zirconiurn, tris(ethylacetoacetato)aluminum. Dibutyltin alkyl esters such as dibutyltin alkyl maleates or dibutyltin laurates are particularly suitable, especially dibutyltin bis-ethyl maleate, dibutyltin bis-butyl maleate, dibutyltin bis-octyl maleate, dibutyltin bis-oleyl maleate, dibutyltin bis-acetylacetate, dibutyltin diacetate, dibutyltin dioctoate, dibutyltin oxide, dibutyltin bis-triethoxy silicate and their catalytically active derivatives. The cited catalysts can be used alone or as a mixture of two or more of the cited catalysts.

The inventive preparations can comprise up to 5 wt. % of such catalysts in the total composition.

In addition, the inventive preparations can comprise up to about 7 wt. %, particularly about 3 to 5 wt. % antioxidants in the total composition.

The stabilizers or antioxidants suitable for use as additives in accordance with the present invention include sterically hindered phenols of high molecular weight (M_{w}), polyfunctional phenols and sulfur- and phosphorus-containing phenols. Exemplary phenols that can be used as additives in the context of the invention 1,3,5-trimethyl-2,4,6-tris(3,5-di-tert-butyl-4-hydroxybenzyl)benzene; pentaerythritol tetrakis-3-(3,5-di-tert-butyl-4-hydroxyphenyl)propionate; n-octadecyl 3,5-di-tert-butyl-hydroxyphenyl)propionate; 4,4-methylene bis(2,6-di-tert-butyl-phenol); 4,4-thiobis(6-tert-butyl-o-cresol); 2,6-di-tert-butylphenol; 2,4-dimethyl-6-tert-butylphenol, 2,2-methylene-bis-(4-methyl-6-tert-butylphenol; 4,4-butylidene-bis-(3-methyl-6-tert-butylphenol); 4,4-thiobis(3-methyl-6-tert-butylphenol); 2,6-di-tert-butyl-p-cresol; 6-(4-hydroxyphenoxy)-2,4-bis(n-octylthio)-1,3,5-triazine; tetrakis[methylene-3-(3,5-di-tert-butyl-4-hydroxyphenyl)propionate]methane; 1,1,3-tris(2-methyl-4-hydroxy-4-tert-butylphenyl)butane; di-n-octadecyl-3,5-di-tert-butyl-4-hydroxybenzyl phosphonate; 2-(n-octylthio)ethyl-3,5-di-tert-butyl-4-hydroxybenzoate; and sorbitol hexa[3-(3,5-di-tert-butyl-4-hydroxyphenyl) propionate].

Suitable photostabilizers are for example those that are commercially available under the trade name Tinuvin® (manufacturer: Ciba Geigy).

Suitable stabilizers that represent typical UV absorbers and light stabilizers can also be comprised, preferably selected from the groups of the oxanilides, triazines and benzotriazoles (the last being available as the Tinuvin® types of Ciba-Spezialitatenchemie) and benzophenones or combinations thereof. It can be advantageous to add light stabilizers that do not absorb UV light.

A selection of suitable preferred UV absorbers and light stabilizers that can be comprised in the inventive preparations are:

2-Hydroxybenzophenone, for example the 4-hydroxy-, 4-methoxy-, 4-octyloxy-, 4-decyloxy-, 4-dodecyloxy-, 4-benzyloxy-, 4,2′,4′-trihydroxy- and 2′-hydroxy-4,4′-dimethoxy derivatives; esters of substituted and unsubstituted benzoic acids, such as for example 4-tertbutylphenyl salicylate, phenyl salicylate, octylphenyl salicylate, dibenzoyl resorcinol, bis(4-tert-butylbenzoyl)resorcinol, benzoyl resorcinol, 2,4-di-tert-butylphenyl-3,5-di-tert-butyl-4-hydroxybenzoate, hexadecyl 3,5-di-tert-butyl-4-hydroxybenzoate, octadecyl 3,5-di-tert-butyl-4-hydroxybenzoate, 2-methyl-4,6-di-tert-butylphenyl 3,5-di-tert-butyl-4-hydroxybenzoate.

The inventive preparations can comprise up to about 2 wt.%, preferably about 1 wt. % of such UV stabilizers in the total composition.

The preparations according to the invention can further comprise impact additives (impact modifiers).

Exemplary suitable impact additives are terminally-functionalized or non terminally-functionalized thermoplastics such as polysulfones, polyphenylsulfones, polyether sulfones (e.g. Radel and Udel from Solvay, or Ultrason from BASF), polyether ether ketones, polyether ketones, polybutylene terephthalates, polycarbonates, polyether imides, polyethylene, nylon, polyamide imides, polyaryl ethers, polyesters, polyarylates.

Suitable elastomers, which likewise act as impact modifiers, are for example EPDM or EPM rubber, polyisobutylene, butyl rubber, ethylene vinyl acetate, hydrogenated block copolymers of dienes (e.g. hydrogenated SBR, cSBR, SBS, SIS or IR; such polymers are for example known as SEPS and SEBS), copolymers of styrene, butadiene and ethylene, or styrene, butylene, ethylene, butadiene, butyl rubber, neoprene rubber, and polysiloxanes.

In addition, polymers can be used as impact additives that have a molecular weight of about 5000 to 2 000 000, preferably 10 000 to 1 000 000, such as preferred homopolymers and copolymers of acrylates and methacrylates, copolymers of methyl methacrylate/ethyl acrylate/methacrylic acid, poly(alkyl methacrylates), poly(alkyl acrylates); cellulose esters and ethers such as cellulose acetate, cellulose acetobutyrate, methyl cellulose, ethyl cellulose; polyvinyl butyral, polyvinyl formal, cyclized rubber, polyethers such as polyethylene oxide, polypropylene oxide, polytetrahydrofuran; polystyrene, polycarbonate, polyurethane, chlorinated polyolefins, polyvinyl chloride, copolymers of vinyl chloride/vinylidene chloride, copolymers of vinylidene chloride with acrylonitrile, methyl methacrylate and vinyl acetate, polyvinyl acetate, ethylene/vinyl acetate, polymers such as polycaprolactam and poly(hexamethylene adipamide), polyesters such as poly(ethylene glycol terephthalate) and poly(hexamethylene glycol succinate).

Suitable nanoparticles that can likewise be employed as impact modifiers are especially those based on silicon dioxide (e.g. Nanopox from Nanoresins), aluminum oxide, zirconium oxide and barium sulfate. They preferably have a particle size of less than 50 nm. Exemplary suitable nanoparticles based on silicon dioxide are pyrogenic silicon dioxides, which are commercialised under the trade names Aerosil® VP8200, VP721 or R972 by Degussa or the trade names Cab O Sil® TS 610, CT 1110F or CT 1110G by CABOT. “Multi-wall” and “Single-wall” nanotubes with a modified or non-modified surface can likewise be used. Nanoparticles in the form of dispersions are also conceivable, for example dispersions that are commercialized under the trade name High Link® OG 103-31 by Clariant Hoechst.

Suitable core-shell particles, which e.g. have a crosslinked silica core and a functionalized shell (e.g. Genioperl from Wacker, Albidur from Nanoresins) or which have e.g. a rubber core (e.g. Zeon, Kaneka) as well as suitable highly functionalized polymers e.g. polyols, dendritic polymers (e.g. Boltorn from Perstorp) and polyesters, can also be employed.

The inventive preparations can comprise up to 90 wt. %, preferably up to 80 wt. %, particularly preferably up to 50 wt. % impact additives in the total composition.

Moreover, the inventive preparations can comprise thermal inhibitors, which are intended to prevent a premature polymerization.

Suitable inhibitors are for example hydroquinone, hydroquinone derivatives, p-methoxyphenol, β-naphthol or sterically hindered phenols such as 2,6-di(tert-butyl)-p-cresol.

Suitable dispersants are water-soluble organic compounds of high molecular weight, which carry polar groups, for example polyvinyl alcohols, polyethers, polyvinyl pyrrolidone or cellulose ethers.

Suitable emulsifiers can be non-ionic emulsifiers and in some cases ionic emulsifiers can also be used.

Moreover, it is also possible to incorporate other initiators known from the prior art into the inventive preparations in order to support the polymerization initiated by the inventive initiators.

Thus, thermally activatable initiators can be added, selected from organic azo compounds, organic peroxides, C—C cleaving initiators such as benzpinacol silyl ether, hydroxy imides such as N-hydroxyphthalimide or N-hydroxysuccinimide. The thermally activatable peroxy compounds that are suitable initiators include representatives of the various peroxy compounds, such as disuccinoyl peroxide, potassium peroxydisulfate, cyclohexylsulfonylacetyl peroxide, dibenzoyl peroxide, cyclohexanone peroxide, di-tert-butyl peroxide, dialkyl peroxides, diacyl peroxides, peroxydicarbonates, perketals, peroxycarboxylic acids and their esters, ketone peroxides and/or hydroperoxides. Di(3,5,5-trimethylhexanoyl)peroxide, didecanoyl peroxide, dilauroyl peroxide, dibenzoyl peroxide, di(2-ethylhexyl)peroxydicarbonate, dicyclohexylperoxydicarbonate, di(4-tert-butylcyclohexyl)peroxydicarbonate, dimyristylperoxydicarbonate, diacetylperoxydicarbonate, di-tert-butylperoxyoxalate as well as peroxycarboxylic acid esters from the reaction products of pivalic acid, neodecanoic acid or 2-ethylhexanoic acid and tert-butyl hydroperoxide, tert-amyl hydroperoxide, cumyl hydroperoxide, 2,5-dimethyl-2,5-dihydroperoxy-hexane, 1,3-di(2-hydroxyperoxyisopropyl)benzene are particularly preferred.

A system of two or more of the abovementioned thermally activatable initiators can also be considered.

In another embodiment, the initiators in the inventive preparation can be employed with other initiators. They can be for example photoinitiators known to the person skilled in the art.

Suitable preferred photoinitiators are for example benzophenone, acetophenone, acetonaphthoquinone, methyl ethyl ketone, valerophenone, hexanophenone, α-phenylbutyrophenone, p-morpholinopropiophenone, dibenzosuberone, 4-morpholinobenzophenone, 4-morpholinodeoxybenzoin, p-diacetylbenzene, 4-aminobenzophenone, 4′-methoxyacetophenone, β-methylanthraquinone, tert-butylanthraquinone, anthraquinone carboxylic acid esters, benzaldehyde, α-tetralone, 9-acetylphenanthrene, 2-acetylphenanthrene, 10-thioxanthenone, 3-acetylphenanthrene, 3-acetylindole, 9-fluorenone, 1-indanone, 1,3,4-triacetylbenzene, thioxanthen-9-one, xanthen-9-one, 2,4-dimethylthioxanthone, 2,4-diethylthioxanthone, 2,4-di-iso-propylthioxanthone, 2,4-dichlorothioxanthone, benzoin, benzoin iso-butyl ether, chloroxanthenone, benzoin tetrahydropyranyl ether, benzoin methyl ether, benzoin ethyl ether, benzoin butyl ether, benzoin iso-propyl ether, 7-H-benzoin methyl ether, benz[de]anthracen-7-one, 1-naphthaldehyde, 4,4′-bis(dimethylamino)benzophenone, α-phenylbenzophenone, 4-chlorobenzophenone, Michler's ketone, 1-acetonaphthone, 2-acetonaphthone, 1-benzoylcyclohexan-1-ol, 2-hydroxy-2,2-dimethylacetophenone, 2,2-dimethoxy-2-phenylacetophenone, 2,2-diethoxy-2-phenylacetophenone, 1,1-dichloroacetophenone, 1-hydroxyacetophenone, acetophenone dimethyl ketal, o-methoxybenzophenone, triphenylphosphine, tri-o-tolylphosphine, benz[a]anthracene-7,12-dione, 2,2-diethoxyacetophenone, benzil ketals, such as benzil dimethyl ketal, 2-methyl-1-[4-(methylthio)phenyl]-2-morpholinopropan-1-one, anthraquinones such as 2-methylanthraquinone, 2-ethylanthraquinone, 2-tert-butylanthraquinone, 1-chloroanthraquinone, 2-amylanthraquinone and 2,3-butane dione, 2,4,6-trimethylbenzoyldiphenylphosphine oxide (Lucirin® TPO from BASF AG), ethyl-2,4,6-trimethylbenzoylphenylphosphinate (Lucirin® TPO L from BASF AG), bis-(2,4,6-trimethylbenzoyl)-phenylphosphine oxide (Irgacure® 819 from Ciba Spezialiätenchemie), benzophenones, hydroxyacetophenones, phenylglyoxylic acid and their derivatives or mixtures of these photoinitiators.

Tin octoate, zinc octoate, dibutyltin laurate or diaza[2.2.2]bicyclooctane can be preferably used in the inventive preparations as an accelerator for the thermal post curing.

In another preferred embodiment of the inventive preparation, beside the initiators, a combination of a thermally activatable initiator and a photochemical initiator is additionally employed in the inventive preparations. This has the advantage that initiators can be employed that are optimized for their application area.

The inventive preparation, which comprises an inventive initiator, at least one inventive flame-retardant and an inventive epoxy resin system, is preferably not curable by heat.

Due to the chemical structure of the inventive initiators, the non-thermal curing of the preparation is essentially a cationic polymerization process.

In the present invention, the term, “non-thermal” is understood to mean radiation-initiated curing, which does not include thermal initiation caused by targeted and actively supplied thermal energy. In “non-thermal” curing, thermal energy can result from the radiation-initiated curing.

The non-thermal curing, due to the inventive initiators, results predominantly according to a cationic mechanism.

The inventive preparation is preferably cured by irradiation having a wavelength of at least 1 mm, advantageously at least 780 nm, preferably at least 1 nm, quite particularly preferably of at least 10 pm.

The inventive preparation is preferably curable by radiation selected from X-rays, gamma, electron beam, UV and/or microwave radiation.

There are no specific limitations in regard to the radiation source.

The source for UV radiation is preferably a mercury lamp, a halogen lamp although monochromatic radiation from a laser source can also be used.

If UV radiation is used for curing, then the UV crosslinking is preferably carried out by means of short-term ultraviolet irradiation in a wavelength range of 200 to 450 nm, in particular with a high-pressure or medium-pressure mercury lamp at a power of 80 to 240 W/cm.

As an example of the source for electron beam radiation, a system can be employed that utilizes thermo-electrons, produced by commercially available tungsten filaments, a cold cathode process that generates electron beams by passing a high voltage impulse through a metal, and a secondary electron process that utilizes secondary electrons, produced by the collision of ionized gas molecules, and a metal electrode. Fissile materials, such as Co⁶⁰, can be utilized as a source of α-radiation, β-radiation and γ-radiation. A vacuum tube that brings about the collision of an accelerated electron with an anode can be used for γ-radiation. The radiation can either be unique or be a combination of two or more radiation types. In the latter case, two or more radiation types can be either used simultaneously or for defined periods.

The radiation curing, particularly by electron beam radiation, is preferably carried out at 15° C. to 50° C. for a period of 5 seconds to 12 hours, preferably 8 seconds to 4 hours, quite particularly preferably 10 seconds to 1 hour. The samples can be heated to much higher temperatures by the resulting heat of reaction.

In a preferred embodiment, the radiation used for curing the inventive preparation is an ionizing radiation, preferably X-ray and/or electron beam radiation.

In another preferred embodiment, the inventive preparation is cured by cationic polymerization, wherein the polymerization is preferably initiated by electron beam radiation.

Curing or polymerization by means of electron beam radiation has the advantage that the radiation, depending on the selected irradiation energy, almost completely penetrates the material to be cured, thereby better allowing a homogeneous and complete cure to be achieved. Moreover, in the presence of cationic initiators, a large number of cations for the polymerization is released by the energy-rich radiation.

Furthermore, a curable preparation that is curable with 3 eV to 25 MeV, particularly with 6 eV to 20 MeV, preferably with 1 keV to 15 MeV, quite particularly preferably with 1 keV to 10 MeV, is preferred.

In a preferred embodiment, the inventive preparation is cured with a freely chosen irradiation unit of 1 to 1000 kGy, preferably 1 to 300 kGy, particularly preferably 10 to 200 kGy.

The preparation can be cured particularly with 132 kGy in 4 steps of 33 kGy each.

In a preferred embodiment of the invention, a combination of thermal and non-thermal curing can also be undertaken.

Thus, a non-thermal curing step can be initially carried out followed by a thermal curing step.

If it is intended to carry out the thermal and non-thermal curing in the absence of oxygen or air, then the curing can also be carried out under inert gas.

In principle any gas is a suitable inert gas, which maintains the chemicals inert. In this respect, one can preferably consider N₂, CO₂ or Ar. However, cheap gases such as CO₂ and N₂ are preferred. CO₂ has the advantage that it concentrates at the base of recipients and is therefore easily manipulated. Suitable inert gases are neither poisonous nor inflammable.

A further subject matter of the present invention relates to the already cited use of the inventive preparation as an adhesive, composite material, sealing compound, material and/or for coating surfaces.

In a preferred embodiment, an inventive preparation of this type can be deposited as a coating compound onto a surface and subsequently cured. Particularly suitable substrates are preferably wood, cardboard, textiles, leather, non-wovens, plastics (polycarbonate, polymethacrylate, polystyrene, polyester, polyolefin, epoxy resins, melamine resins, triacetylcellulose resins, ABS resins, AS resins, norbornene resins etc.). The substrate can also be a sheet, a film or a three dimensionally shaped object.

Various application methods can be used as a method for coating the preparation (in this case as a coating compound) onto the substrate such as injection, flow coating, coating, painting, casting, dipping, trickling, roller coating, screen coating or dip coating.

In this regard the substrate to be coated can be stationary whereby the application equipment or unit is moved. However, the substrate to be coated can also be moved, in which case the application equipment is stationary relative to the substrate or is moved in an appropriate manner.

Another subject matter of the present invention is the already cited process for curing the inventive preparation, comprising the steps
a) providing a curable preparation,
b) irradiating said preparation with radiation, which is sufficient to cure said preparation and the cured product as such, which is obtained by non-thermal curing of the inventive preparation, preferably by the abovementioned process.

In a preferred embodiment of the invention, the cited cured product is a coating, a film, a material, a composite material, an adhesive and/or a sealing compound.

The following examples illustrate the invention without, however, limiting it in any way.

### EXAMPLES

### Example 1

### Synthesis of Silver Alkene Complexes and Additional Complexes with SbF₆⁻

The commercially available AgSbF₆ (Aldrich, 98% or Chempur, 95+%) was selected as the starting material for the silver alkene complexes. The synthesis of the complexes was carried out according to the methods cited in the literature (H. W. Quinn, R. L. Van Gilder, Can. J. Chem. 1970, 48, 2435; A. Albinati, S. V. Meille, G. Carturan, J. Organomet. Chem. 1979, 182, 269; H. Masuda, M. Munakata, S. Kitagawa, J. Organomet. Chem. 1990, 391, 131; A J. Canty, R. Colton, Inorg. Chim. Acta 1994, 220, 99). The AgSbF₆ was dissolved in toluene or THF and treated with an excess of alkene, preferably four equivalents of alkene. The alkene complexes {[Ag(alkene)ₐ]SbF₆}_{c} are poorly soluble and precipitate out of the reaction mixture and can be isolated by filtration. The substances were then dried under high vacuum.

For other metals and ligands the metal chloride is initially treated with AgSbF₆ in a suitable solvent such as methanol, the precipitated AgCl is separated by filtration and the resulting solution of the metal hexafluoroantimonate is treated with the appropriate ligand. The solvent was then removed and the compound was dried under high vacuum.

### Example 2

### Synthesis of the Inventive Flame-Retardant Additive

### Example 2a

### Typical Synthesis of a Phosphonium Hexafluoroantimonate from the Corresponding Halides by Ion Exchange

35 g (103 mmol) allyltriphenylphosphonium chloride (CAS 18480-23-4) were dissolved in 88 ml water and 34 g (124 mmol) KSbF₆ (CAS 16893-92-8) were dissolved in 75 ml water. The KSbF₆ solution was added over a period of 15 min to the phosphonium salt solution with vigorous stirring, whereupon the phosphonium hexafluoroantimonate (V) precipitated out. The suspension was stirred for a further 3 h at room temperature and the precipitated solid was then separated by filtration. The solid was washed with 70 ml water three times and then with 70 ml diethyl ether. The colorless solid was dried under vacuum at 50° C. Yield: 50 g (93 mmol, 90%).

### Example 2b

### Synthesis of the Flame-Retardant Additive (VII) from the Corresponding Chloride

50 g (135 mmol) (methoxycarbonylmethyl)triphenyl phosphonium chloride were dissolved in 130 ml water and 44.5 g (162 mmol) KSbF₆ were dissolved in 180 ml water. The KSbF₆ solution was added over a period of 15 min to the phosphonium chloride solution, whereupon the product precipitated out as a colorless precipitate. Stirring was continued for a further 3 hours, the phosphonium hexafluoroantimonate was isolated by filtration and washed with 100 ml water three times and then with 100 ml diethyl ether. The product was then dried under vacuum at 50° C. Yield: 71.3 g (125 mmol, 92%).

M.pt.: 113° C.

¹H NMR (DMSO-d₆): δ 3.60 (s, 3H), 5.34 (d, 2H), 7.76-7.93 (m, 15H)

³¹P NMR (DMSO-d₆): δ 21.6 (s)

### Example 2c

### Synthesis of the Flame-Retardant Additive (X)

### a) Synthesis of the Diphosphonium Chloride

30 g (75 mmol) 1,2-bis-(diphenylphosphino)ethane and 27.9 g (302 mmol) chloroacetone were dissolved in 200 ml DMF and the reaction mixture was stirred for 16 h at 120° C. After cooling to room temperature, the resulting suspension was poured into 200 ml diethyl ether and stirred for a further 2 h. The colorless precipitate was separated by filtration and washed with 100 ml diethyl ether three times. The diphosphonium chloride was then dried under vacuum at 50° C. Yield: 40 g (69 mmol, 92%).

¹H NMR (D₂O): δ 2.27 (s, 6H), 3.26 (d, 4H), 4.79 (d, 4H), 7.67-7.90 (m, 20H)

¹H NMR (DMSO-d₆): δ 2.30 (br, 6H), 3.60 (br, 4H), 5.45 (br, 4H), 7.53-7.95 (m, 20H)

³¹P NMR (DMSO-d₆): δ 25.5 (s)

### b) Synthesis of the Diphosphonium Hexafluoroantimonate

18.2 g (31 mmol) diphosphonium chloride were dissolved in 560 ml water and 15.9 g (58 mmol) KSbF₆ were dissolved in 55 ml water. The solution of the hexafluoroantimonate was added over a period of 15 minutes to the solution of the diphosphonium chloride, whereupon a colorless precipitate precipitated out. Stirring was continued for a further 3 h at room temperature and the product was then separated by filtration. The product was washed with 100 ml water two times, then with 100 ml diethyl ether and dried at 50° C. under vacuum.

Yield: 25 g (25 mmol, 81%).

M.pt.: 196-202° C.

¹H NMR (DMSO-d₆): δ 2.29 (s, 6H), 3.38 (d, 4H), 5.13 (d, 4H), 7.70-7.88 (m, 20H)

³¹P NMR (DMSO-d₆): δ 25.4 (s)

### Example 2d

### Synthesis of the Flame-Retardant Additive (XI)

### a) Synthesis of the Tetraphosphonium Chloride

10 g (25 mmol) 1,2-bis-(diphenylphosphino)ethane were dissolved in 110 ml DMF and heated to 70° C. To this solution was added a solution of 17.5 g (100 mmol) α,α-dichloro-p-xylene in 110 ml DMF over a period of 15 min. The temperature was then increased to 120° C. and stirring was continued at this temperature for a further 2 h. A colorless precipitate precipitated out, was filtered off and washed with 25 ml DMF three times. The solid was taken up in 100 ml DMF, to which a solution of 26.2 g (100 mmol) triphenylphosphine in 40 ml DMF was added. The reaction mixture was stirred for 16 h at 140° C. After cooling to room temperature, the mixture was first decanted and then centrifuged and the product was washed with 40 ml DMF three times and with 25 ml diethyl ether two times. It was then dried under vacuum at 50° C. Yield: 28 g (22 mmol, 88%).

¹H NMR (D₂O): δ 3.04 (br, 4H), 4.45 (br, 4H), 4.64 (d, 4H) 6.54 (m, 8H), 7.45-7.83 (m, 50H)

³¹P NMR (D₂O): δ 23.4 (m), 29.1 (m)

### b) Synthesis of the Tetraphosphonium Hexafluoroantimonate

10 g (8 mmol) tetraphosphonium chloride were dissolved in 400 ml water and 17 g (62 mmol) KSbF₆ were dissolved in 60 ml water. The KSbF₆ solution was added over a period of 15 min to the tetraphosphonium chloride solution, whereupon the product precipitated out as a colorless precipitate. Stirring was continued for a further 2 h, the product was filtered off and washed with 100 ml water two times and once with 50 ml diethyl ether. The product was then dried under vacuum at 50° C. Yield: 14.2 g (7 mmol, 87%).

M.pt.: 279-288° C. (decomposition)

¹H NMR (DMSO-d₆): δ 3.15 (br, 4H), 4.73 (br, 4H), 5.03 (d, 4H), 6.58 (m, 8H), 7.56-7.92 (m, 50H)

³¹P NMR (DMSO-d₆): δ 24.2 (m), 29.7 (m)

### Example 2d

### Synthesis of the Flame-Retardant Additive (XII)

### a) Synthesis of the Polyphosphonium Chloride

24.8 g (62 mmol) 1,2-bis-(diphenylphosphino)ethane were dissolved in 130 ml DMF and heated to 90° C. A solution of 10.9 g (62 mmol) α,α-dichloro-p-xylene in 100 ml DMF was then added drop wise over a period of 15 min. The reaction mixture was heated to 120° C. and stirred for a further 3 h at this temperature, whereupon the product precipitated out as a colorless precipitate. It was filtered off and then washed with 60 ml DMF followed by 60 ml diethyl ether. The substance was then dried under vacuum at 50° C. Yield of crude product: 36.2 g (still comprising DMF).

¹H NMR (D₂O): δ 2.90 (br, 4H), 4.32 (br, 4H), 6.36 (m, br, 4H), 7.44-7.89 (m, br, 20H)

³¹PNMR (D₂O): δ 29.2 (S)

### b) Synthesis of the Polyphosphonium Hexafluoroantimonate

30 g Polyphosphonium chloride were dissolved in 300 ml water and 35 g (135 mmol) NaSbF₆ were dissolved in 500 ml water. The NaSbF₆ solution was added over a period of 15 min to the polyphosphonium chloride solution, whereupon the product precipitated out as a colorless precipitate. The mixture was stirred for a further 16 h at 50° C. and then filtered. The precipitate was washed with 250 ml water and 250 ml diethyl ether and dried under vacuum at 50° C. Yield: 39 g (77%).

M.pt.: 255-268° C. (decomposition)

¹H NMR (DMSO-d₆): δ 2.99 (br, 4H), 4.53 (br, 4H), 6.32 (m, br, 4H), 7.34-7.86 (m, br, 20H)

³¹P NMR (DMSO-d₆): δ 29.8 (s)

### Example 3

### Synthesis of the Inventive Curable Preparation and Radiation Curing

### a) General Procedure for Preparing the Inventive Curable Preparation

A mixture of the inventive epoxy resin system (40 wt. % to 95 wt. %), the inventive flame-retardant (0.01 wt. % to 50 wt. %) and the inventive initiator (0.1 wt. % to 10 wt. %) and optional additional additives was homogenized within 1 to 100 min with stirring and optional slight heating.

### b) Sample Synthesis of the Different Preparations

The epoxy resin (Novolak DEN 431 from Dow Chemical Co., 100 parts by weight) and the hexafluoroantimonate of the phosphonium salt under consideration (the flame-retardant additive, 10 or 20 parts by weight) according to formula V to XII were combined and blended with stirring for 1-2 minutes at 50° C. The photoinitiator {[Ag(1,7-octadiene)_{1.5}](SbF₆)}ₚ (2 parts by weight) was then added at 50° C. and the preparation was homogenized with stirring.

### c) Radiation Curing

The preparations having the dimensions 7×3.5×3 cm (length×width×height) were transferred in small aluminum bowls and degassed in a vacuum drying oven at 60° C. under a pressure of 15 mbar. The samples were cured by electron beam radiation with a 200 kW Rhodotron accelerator with an electron beam energy of 10 MeV. The total dose of 132 kGy was supplied in 33 kGy steps.

### Example 4

### Burn Behavior Tests According to the UL94-VB Test

The electron beam cured resin plaques (3 mm sample thickness) were demolded, sawn up and tested for their flame-retarding properties using the UL94 vertical burn test in an HVUL2 burn test chamber (Atlas Company). Five independent measurements were carried out on each of the materials. The results of the burn test are presented in Tables 1 to 5. Comparative data for plaques without phosphonium salt additives are presented in Table 1.

TABLE 1
UL94-VB Test with electron beam cured samples without flame-
retardant additive (DEN 431:{[Ag(1,7-octadiene)_{1.5}]SbF₆}ₚ =
100:2; 10 MeV, 4 × 33 kGy)
Sample thickness: 7 ± 1 mm

| Measurement | Total burn time (s) | Classification |
|---|---|---|
| 1 | >30 | Not classified |
| 2 | >30 | |
| 3 | >30 | |
| 4 | >30 | |
| 5 | >30 | |

TABLE 2
UL94-VB Test with electron beam cured samples containing
compound (V) (SbF₆ counter ion)
(DEN 431:(V):{[Ag(1,7-octadiene)_{1.5}]SbF₆}ₚ =
100:20:2; 10 MeV, 4 × 33 kGy)

| Sample thickness: 7 ± 1 mm | | | Sample thickness: 3 ± 1 mm | | |
|---|---|---|---|---|---|
| Measure- | Total burn | | Measure- | Total burn | Classi- |
| ment | time (s) | Classification | ment | time (s) | fication |
| 1 | 5.6 | V0 | 1 | 12.6 | V1 |
| 2 | 3.2 | | 2 | 9.8 | |
| 3 | 6.5 | | 3 | 4.4 | |
| 4 | 6.5 | | 4 | 17.9 | |
| 5 | 20.3 | | 5 | 7.4 | |

TABLE 3
UL94-VB Test with electron beam cured samples containing
compound (VI) (SbF₆ counter ion)
(DEN 431:(VI):{[Ag(1,7-octadiene)_{1.5}]SbF₆}ₚ =
100:20:2; 10 MeV, 4 × 33 kGy)
Sample thickness: 7 ± 1 mm

| Measurement | Total burn time (s) | Classification |
|---|---|---|
| 1 | 3.0 | V1 |
| 2 | 5.2 | |
| 3 | 14.4 | |
| 4 | 21.5 | |
| 5 | 17.8 | |

TABLE 4
UL94-VB Test with electron beam cured samples containing
compound (IX) (SbF₆ counter ion)
(DEN 431:(IX):{[Ag(1,7-octadiene)_{1.5}]SbF₆}ₚ =
100:20:2; 10 MeV, 4 × 33 kGy)

| Sample thickness: 7 ± 1 mm | | | Sample thickness: 3 ± 1 mm | | |
|---|---|---|---|---|---|
| Measure- | Total burn | | Sample | Total burn | Clas- |
| ment | time (s) | Classification | no. | time (s) | sification |
| 1 | 16.7 | V1 | 1 | 20.2 | V1 |
| 2 | 14.2 | | 2 | 6.6 | |
| 3 | 11.7 | | 3 | 7.5 | |
| 4 | 6.7 | | 4 | 9.5 | |
| 5 | 9.8 | | 5 | 29.3 | |

TABLE 5
UL94-VB Test with electron beam cured samples containing
compound (X) (SbF₆ counter ion)
(DEN 431:(X):{[Ag(1,7-octadiene)_{1.5}]SbF₆}ₚ =
100:20:2; 10 MeV, 4 × 33 kGy)
Sample thickness: 7 ± 1 mm

| Sample no. | Total burn time (s) | Classification |
|---|---|---|
| 1 | 36.0 | V1 |
| 2 | 7.5 | |
| 3 | 6.5 | |
| 4 | 3.9 | |
| 5 | 16.5 | |

TABLE 6
UL94-VB Test with electron beam cured samples containing flame-
retardant additive, wherein the flame retardant additives were added in different
concentrations (DEN 431: additive: {[Ag(1,7-octadiene)_{1.5}]SbF₆}ₚ = 100:20 or
10:2; 10 MeV, 4 × 33 kGy)

| | UL94 Vertical burn test |
|---|---|
| Flame-retardant additive | classification |
| 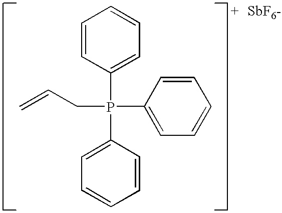 | V0/V1^{[a]} (20 parts by wt.) V1^{[b]} (10 parts by wt.) |
| 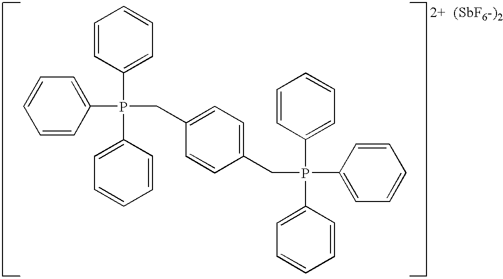 | V0/V1^{[a]} (20 parts by wt.) V1^{[b]} (10 parts by wt.) |

^{[a]}Mean value of five independent determinations with the same material.
^{[b]}Mean value of four independent determinations with the same material.

The results of the demanding UL94 vertical burn test show that the inventive phosphonium salts with hexafluoroantimonate as the counter ion represent effective flame-retardant additives for radiation curable resin systems.

All investigated epoxy resin systems clearly possess flame-retardant properties and satisfy at least the overall classification V1. The phosphorus and antimony contents in the resin formulations are very low; very good results were obtained even with low additive contents (10 to 20 parts by weight in the resin) and without adding any other flame-retardants (synergists).

1. Use of at least one compound of the general formula (I),
KA (I)
with K=mono-, di-, oligo- and/or polyphosphonium cation and A=weakly coordinating anion, wherein the weakly coordinating anion A is selected from hexafluoroantimonate (SbF₆⁻), hexafluorophosphate (PF₆⁻), tetrafluoroborate (BF₄⁻), hexafluoroaluminate (AlF₆³⁻), trifluormethanesulfonate (CF₃SO₃⁻), hexafluoroarsenate (AsF₆⁻), tetrakis(pentafluorophenyl)borate (B[C₆F₅]₄⁻), tetrakis[3,5-bis(trifluoromethyl)phenyl]borate (B[C₆H₃(CF₃)₂]₄⁻), tetra phenyl borate (B[C₆H₅]₄⁻), hexafluorotitanate (TiF₆²⁻), pentachlorotitanate (TiCl₅⁻), pentachlorostannate (SnCl₅⁻), hexafluorogermanate (GeF₆²), hexafluorosilicate (SiF₆²⁻), hexafluoronickelate (NiF₆²⁻) or hexafluorozirconate (ZrF₆²⁻) as flame-retardants for resin systems.

2. Use according to claim 1, wherein the resin system concerns a non-thermally curable epoxy resin system.

3. Use according to claim 1 wherein the monophosphonium cation is selected from compounds of the general formula (II), 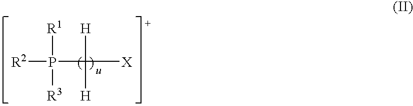
wherein u is a whole number between 0 and 18, R¹, R² and R³ independently of each other stand for a substituted or unsubstituted C₁₋₁₂ alkyl, cycloalkyl, alkenyl, alkynyl, arylalkyl or aryl group, and X stands for a C₁₋₁₂ alkyl, alkenyl, cycloalkyl, arylalkyl, aryl, carboxylic acid or carboxylic acid ester group or an acyl group of the general formula R⁴(C═O)—, with R⁴=substituted or unsubstituted C₁₋₁₂ alkyl, cycloalkyl, arylalkyl or aryl group.

4. Use according to claim 1 wherein the diphosphonium cation is selected from compounds of the general formula (III), 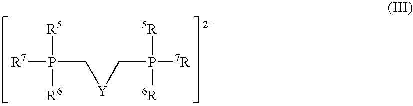
wherein R⁵ and R⁶, independently of each other stand for a substituted or unsubstituted C₁₋₁₂ alkyl, cycloalkyl, alkenyl, alkynyl, arylalkyl or aryl group, R⁷ stands for a substituted or unsubstituted C₁₋₁₂ alkyl, cycloalkyl, alkenyl, alkynyl, arylalkyl or aryl group or for a structure of the general formula R⁸C═O(CH₂)_{u′}, with u′=1 to 10 and R⁸=substituted or unsubstituted C₁₋₁₂ alkyl, cycloalkyl, arylalkyl or aryl group, and Y stands for a covalent bond or a substituted or unsubstituted C₁₋₁₂ alkylene, cycloalkylene, alkenylene, arylalkylene or arylene group.

5. Use according to claim 1 wherein the oligo- or polyphosphonium cation is selected from compounds of the general formula (IV), 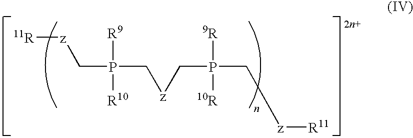
wherein n is a whole number between 1 and 20 000 000, R⁹ and R¹⁹ independently of each other stand for a substituted or unsubstituted C₁₋₁₂ alkyl, cycloalkyl, alkenyl, alkynyl, arylalkyl or aryl group, z for a covalent bond or a substituted or unsubstituted C₁₋₁₂ alkylene, cycloalkylene, alkenylene, arylalkylene or arylene group and R¹¹ stands for a structure of the general formula (R¹²)₃P(CH₂)ⱼ— with j=0 to 10 and R¹²=substituted or unsubstituted C₁₋₁₂ alkyl, cycloalkyl, arylalkyl or aryl group.

6. Use according to claim 1, wherein the flame-retardant is selected from compounds corresponding to formula (V) to (XII) 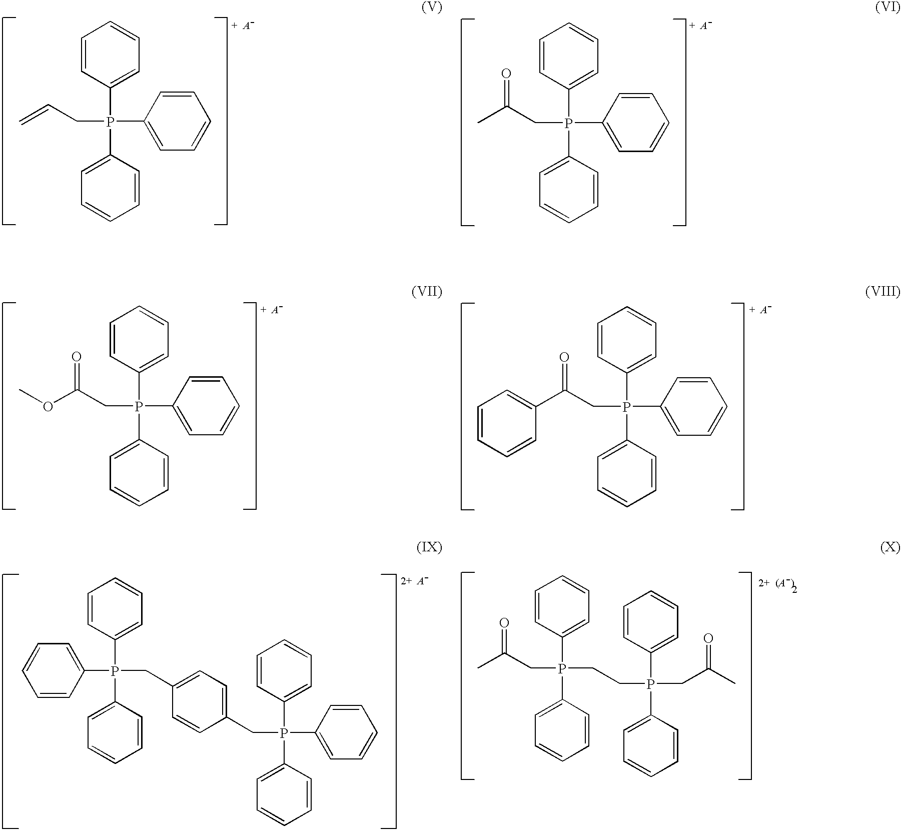 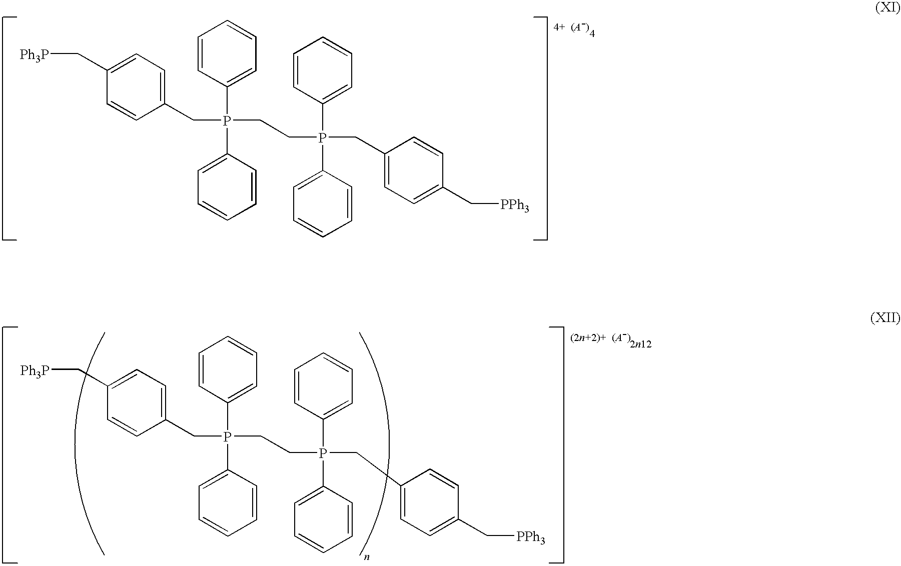
wherein n in formula (XII) is a whole number between 1 and 20 000 000.

7. Use according to claim 1 wherein the weakly coordinating anion A is hexafluoroantimonate (SbF₆⁻).

8. Di-, oligo- or polyphosphonium cations of the compounds according to formula (X) to (XII) and the hexafluoroantimonates of the compounds according to formula (VII), (X), (XI) and (XII), each of claim 6.

9. A curable preparation, comprising
a) an epoxy resin system,
b) an initiator selected from the following compounds or their mixtures:
i) compounds of the general formula (XV),
{[M(L)ₐ]A_{b}}_{c} (XV),
with M=metal cation, L=ligand, A=weakly coordinating anion, a=1 to 10, b=1 to 10 and c=1 to 20 000 000, wherein a, b and c can represent whole numbers and numerical ranges and a can also additionally represent non whole numbers,
ii) compounds of the general formula (XVI),
IA (XVI)
with I=diaryliodonium salt and A=weakly coordinating anion or
iii) compounds of the general formula (XVII),
SA (XVII)
with S=triarylsulfonium salt and A=weakly coordinating anion,
c) at least one flame-retardant of the general formula (I)
KA (I),
with K=mono-, di-, oligo- and/or polyphosphonium cation
and A=weakly coordinating anion,
wherein the weakly coordinating anion A of the initiator and of the flame-retardant is selected from hexafluoroantimonate (SbF₆⁻), hexafluorophosphate (PF₆⁻), tetrafluoroborate (BF₄⁻), hexafluoroaluminate (AlF₆³⁻), trifluormethanesulfonate (CF₃SO₃⁻), hexafluoroarsenate (AsF₆⁻), tetrakis(pentafluorophenyl)borate (B[C₆F₅]₄⁻), tetrakis[3,5-bis(trifluoromethyl)phenyl]borate (B[C₆H₃(CF₃)₂]₄⁻), tetraphenylborate (B[C₆H₅]₄⁻), hexafluorotitanate (TiF₆²⁻), pentachlorotitanate (TiCl₅⁻), pentachlorostannate (SnCl₅⁻), hexafluorogermanate (GeF₆²⁻), hexafluorosilicate (SiF₆²⁻), hexafluoronickelate (NiF₆²⁻) or hexafluorozirconate (ZrF₆²⁻).

10. The preparation according to claim 9 wherein the weakly coordinating anion A of the initiator and/or of the flame-retardant is hexafluoroantimonate (SbF₆⁻).

11. The preparation according to claim 9 wherein the initiator according to formula (XV) is selected from [Ag(cyclohexene)₁₋₄]SbF₆, [Ag(cyclooctene)₁₋₄]SbF₆, [Ag(cyclododecene)₁₋₄]SbF₆, [Ag(trans-2-octene)₁₋₄]SbF₆, [Ag(styrene)₁₋₄]SbF₆, [Ag(5-norbornene-2-carboxylic acid)₁₋₄]SbF₆, {[Ag(1,5-hexadiene)₁₋₄]SbF₆}₁₋ₚ, {[Ag(1,7-octadiene)_{1.5}]SbF₆}ₚ, {[Ag(1,7-octadiene)_{1.5}]SbF₆}₁₀₀₀, {[Ag(1,7-octadiene)₁₋₅]SbF₆}₅₀₀, {[Ag(1,9-decadiene)₁₋₄]SbF₆}₁₋ₚ, {[Ag(ethyl sorbate)₁₋₄]SbF₆)₁₋ₚ, {[Ag(1,3-cyclohexadiene)₁₋₄]SbF₆}₁₋ₚ, {[Ag(1,3-cyclooctadiene)₁₋₄]SbF₆}₁₋ₚ, Ag(1,5-cyclooctadiene)₂]SbF₆, {[Ag(norbornadiene)₁₋₄]SbF₆}₁₋ₚ, {[Ag(dicyclopentadiene)₁₋₄]SbF₆}₁₋ₚ, {[Ag(cycloheptatriene)₁₋₄]SbF₆}₁₋ₚ, {[Cu(1,7-octadiene)₁₋₄]SbF₆}₁₋ₚ, [Cu(1,5-cyclooctadiene)₂]SbF₆, [Cu(15-crown-5)]SbF₆, [Fe(15-crown-5)](SbF₆)₃, [Fe(18-crown-6)](SbF₆)₃, [Mg(15-crown-5)](SbF₆)₂, [Co(15-crown-5)](SbF₆)₂, [Ag(1R-(−)-nopol)₁₋₄]SbF₆, [Ag(allyl glycidyl ether)₁₋₄]SbF₆, {[Ag(trans,trans,cis-1,5,9-cyclododecatriene)₁₋₄]SbF₆}₁₋ₚ, {[Ag(trans,trans,trans-1,5,9-cyclododecatriene)₁₋₄]SbF₆}₁₋ₚ, {[Ag(cyclooctatetraene)₁₋₄]SbF₆}₁₋ₚ, ([Ag(squalene)₁₋₄]SbF₆}₁₋ₚ, and/or from any mixtures thereof, wherein p=20 000 000,
and/or the initiator according to formula (XVI) is selected from compounds of formula (XVIII), 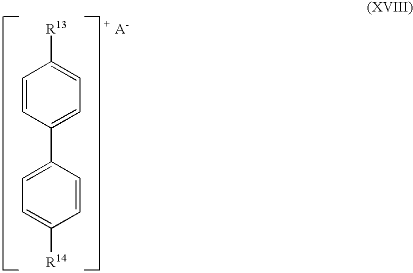
wherein R¹³ and R¹⁴ independently of one another are selected from the group consisting of hydrogen, methyl, ethyl, n-propyl, isopropyl, n-butyl, tert-butyl, Cl, Br, OCᵢH₂ᵢ₊₁, OCH₂CH(CH₃)CᵢH₂ᵢ₊₁, OCH₂CH(C₂H₅)CᵢH₂ᵢ₊₁, OCH₂CH(OH)CᵢH₂ᵢ₊₁, OCH₂CO₂CᵢH₂ᵢ₊₁, OCH(CH₃)CO₂CᵢH₂ᵢ₊₁, OCH(C₂H₅)CO₂CᵢH₂ᵢ₊₁ and i is a whole number between 0 and 18;
and/or
the initiator according to formula (XVII) is selected from compounds of formula (XIX) and/or formula (XX), 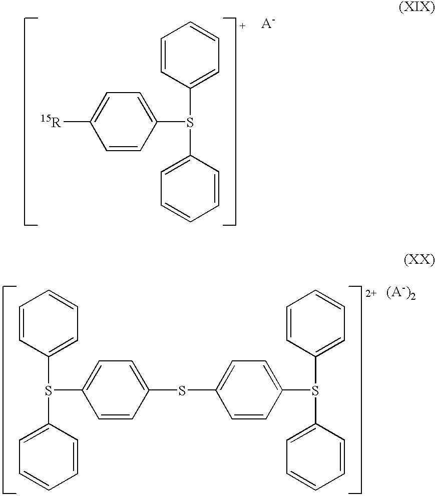
wherein R¹⁵ is selected from the group consisting of hydrogen, methyl, ethyl, n-propyl, isopropyl, n-butyl, tert-butyl, phenyl sulfide (PhS) and phenoxy (PhO).

12. The preparation according to claim 9 wherein the fraction of the initiator in the total amount of the preparation is 0.01 to 10 wt. %.

13. The preparation according to claim 9 wherein the fraction of the flame-retardant in the total amount of the preparation is 0.01 to 50 wt. %.

14. The preparation according to claim 9 wherein the preparation is non-thermally curable.

15. Use of a preparation according to claim 9 as an adhesive, composite material, sealing compound, basic material and/or for coating surfaces.

16. A process for curing a preparation comprising the step of:
a) providing a preparation according to claim 9, and
b) irradiating said preparation with radiation that is sufficient to cure said preparation.

17. A cured product that is manufactured by non-thermal curing of a preparation according to claim 9.

18. The cured product according to claim 17 wherein the product is a coating, a film, a basic material, a composite material, an adhesive and/or a sealing compound.
